(19) United States
(12) Patent Application Publication
(10) Pub. No.: US 2008/0284684 A1
(43) Pub. Date: Nov. 20, 2008

(54) PLASMA DISPLAY DEVICE AND METHOD FOR DRIVING PLASMA DISPLAY PANEL

(75) Inventors: Mitsuhiro ISHIZUKA, Chuo-shi (JP); Mitsuyoshi Makino, Chuo-shi (JP); Hajime Homma, Chuo-shi (JP); Koji Hashimoto, Chuo-shi (JP); Masanori Ishihara, Chuo-shi (JP); Tsutomu Tokunaga, Chuo-shi (JP); Tatsuya Sugimoto, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku (JP)

(21) Appl. No.: 12/119,826

(22) Filed: May 13, 2008

(30) Foreign Application Priority Data
May 17, 2007 (JP) 2007-131795

(51) Int. Cl. G09G 3/28

(52) U.S. Cl. 345/60

(57) ABSTRACT

A plasma display device and a method for driving the plasma display device are provided, wherein deterioration in image quality in a period immediately after power-on can be restrained while improving dark contrast. When driving a PDP, by applying various drive pulses, that includes a phosphor layer containing a secondary electron emissive material in respective discharge cells, drive pulses having different pulse waveforms are generated in a period from power-on of the plasma display device to after a lapse of a predetermined period of time, and in a period after a lapse of the predetermined period of time.

### BACKGROUND OF THE INVENTION

1. Field of the Invention

The present invention relates to a plasma display device including a plasma display panel and a method for driving the plasma display panel.

2. Description of the Related Art

The Plasma display device including a plasma display panel (hereinafter called PDP) has been commercialized as a slim big-screen display device. Discharge cells corresponding to pixels are arranged on the plasma display device in a matrix.

Furthermore, a PDP has been proposed whose discharge probability has been increased by including vapor phase grown magnesium oxide monocrystals in a magnesium oxide layer provided in each of the discharge cells to cover electrodes. By the irradiation of electron beams the vapor phase grown magnesium oxide monocrystals emit cathode luminescence (CL) light having a peak within a wavelength range of 200 to 300 nm. See Japanese Patent Kokai No. 2006-91437, for example. According to such a PDP, a discharge time lag can be drastically cut down and it becomes possible to stably generate faint discharge in a short period of time. Thus, luminescence accompanying discharge unrelated to an image displayed (such as reset discharge) can be restrained, and it becomes possible to improve so-called dark contrast, contrast when a dark image is being displayed.

### SUMMARY OF THE INVENTION

However, the plasma display device having a PDP of the above construction has had a problem that discharge operation in each of the discharge cells are dispersed for a predetermined period of time after power-on, for example, for about a minute, thus causing deterioration in displayed images.

The present invention has been made to solve the above problem. An object of the present invention is to provide a plasma display device and a method for driving a plasma display panel, wherein deterioration in image quality can be restrained immediately after power-on while improving dark contrast.

According to one aspect of the present invention, there is provided a plasma display device that drives a plasma display panel in accordance with pixel data for each pixel based on a video signal. The plasma display panel has discharge cells formed at respective intersections of a plurality of row electrode pairs and a plurality of column electrodes. The plasma display device comprises a phosphor layer formed on a surface of each discharge cell and containing a secondary electron emissive material, and a drive part for applying drive pulses to the row electrode pairs and the column electrodes in each of a plurality of subfields for every unit display period of the video signal. The drive part changes a pulse waveform of the drive pulse for a period from power-on of the plasma display device to the lapse of a predetermined period of time, and for a period after the lapse of the predetermined period of time.

According to another aspect of the present invention, there is provided a method of driving a plasma display panel in accordance with pixel data for each pixel based on a video signal. The plasma display panel has discharge cells formed at respective intersections of a plurality of row electrode pairs and a plurality of column electrodes, and a phosphor layer formed on a surface of each discharge cell and containing a secondary electron emissive material. The method of driving a plasma display panel comprises applying drive pulses to each of the row electrode pairs and the column electrodes in each of every plurality of subfields for a unit display period of the video signal, and a pulse waveform of the drive pulse is made different for a predetermined period of time from power-on of the plasma display device and a period after the lapse of the predetermined period of time, respectively.

When applying various drive pulses for driving a PDP that has a phosphor layer containing a secondary electron emissive material within a discharge cell, drive pulses having different pulse waveforms are generated for a period from power-on of the plasma display device to the lapse of a predetermined period of time, and for a period after the lapse of the predetermined period of time. In other words, drive pulses having peak potentials and/or pulse widths different from each other are generated for a period from power-on to the lapse of the predetermined period of time, and for a period after the lapse of the predetermined period of time. Here, the peak potential of the drive pulse generated for the period between power-on to the lapse of the predetermined period of time is set to be higher than that of the drive pulse generated for the period after the lapse of the predetermined period of time. Alternatively, pulse width of the drive pulse generated in the period between power-on and the lapse of the predetermined period of time is set to be wider than that of the drive pulse generated in the period after the lapse of the predetermined period of time. This makes voltages applied to the PDP to be high in the period between power-on and the lapse of the predetermined period of time, so that discharges are easily generated. Thus, it becomes possible to generate various discharge without fail in the period between power-on and the lapse of a predetermined period of time even if the discharge characteristics in the respective display cells show large variations during the period due to the effects of the secondary electron emissive material that are provided in the discharge cells to improve dark contrast. Accordingly, deterioration in image quality at power-on can be suppressed while improving dark contrast.

### BRIEF DESCRIPTION OF THE DRAWINGS

FIG. 1 is a diagram depicting a general configuration of a plasma display device according to the present invention.

FIG. 2 is a front view schematically depicting the internal structure of a PDP 50 viewed from a display surface side.

FIG. 3 is a cross-sectional view sectioned along a line III-III in FIG. 2.

FIG. 4 is a cross-sectional view sectioned along a line IV-IV in FIG. 2.

FIG. 5 is a diagram schematically depicting MgO crystals contained in a phosphor layer 17.

FIG. 6 is a diagram depicting the transition of discharge intensity in discharge which is generated when a predetermined voltage is applied between row and column electrodes of a conventional PDP using the column electrode as a cathode, where CL light emissive MgO crystals are contained only in a magnesium oxide layer 13 out of the oxide magnesium layer 13 and the phosphor layer 17.

FIG. 7 is a diagram depicting the transition of discharge intensity in discharge which is generated when a predetermined voltage is applied between row and column electrodes of the PDP 50 according to the present embodiment using the column electrode as a cathode, where CL light emissive MgO crystals are contained both in the magnesium oxide layer 13 and the phosphor layer 17.

FIG. 8 is a table depicting an example of a light emission pattern for every grayscale in the plasma display device shown in FIG. 1.

FIG. 9 is a diagram depicting an example of a light emission drive sequence adopted for the plasma display device shown in FIG. 1.

FIG. 10 is a diagram depicting various drive pulses applied to the PDP 50 in a normal mode according to the light emission drive sequence shown in FIG. 9.

FIG. 11 is a flow chart depicting a drive mode setting processing executed by a drive control circuit 56 (560) upon power-on.

FIG. 12 is a diagram depicting various drive pulses applied to the PDP 50 in a start-up mode according to the light emission drive sequence shown in FIG. 9.

FIG. 13 is a diagram depicting operations for generating a reset pulse RP_{Y1}, in the normal mode and start-up mode respectively, which is generated by controlling a rising period thereof.

FIG. 14 is a diagram depicting another waveform of the reset pulse RP_{Y1} (RP1_{Y1}).

FIG. 15 is a diagram schematically depicting a structure when the phosphor layer 17 is constructed by layering a secondary electron emissive layer 18 on a surface of a phosphor particle layer 17a.

FIG. 16 is a diagram depicting another configuration of the plasma display device according to the present invention.

FIG. 17 is a table depicting an example of a light emission pattern for every grayscale in the plasma display device shown in FIG. 16.

FIG. 18 is a diagram depicting an example of a light emission drive sequence adopted for the plasma display device shown in FIG. 16.

FIG. 19 is a diagram depicting various drive pulses applied to the PDP 50 in the normal mode according to the light emission drive sequence shown in FIG. 18.

FIG. 20 is a diagram depicting various drive pulses applied to the PDP 50 in the start-up mode according to the light emission drive sequence shown in FIG. 18.

FIG. 21A and FIG. 21B are diagrams depicting operations for generating a reset pulse RP1_{Y1} (RP2_{Y1}), in the normal mode and start-up mode respectively, which is generated by controlling a rising period thereof.

FIG. 22 is a diagram depicting another example of the application of the reset pulse in a first reset process R1.

### DETAILED DESCRIPTION OF THE INVENTION

Embodiments of the present invention will be hereinafter described in detail with reference to the drawings.

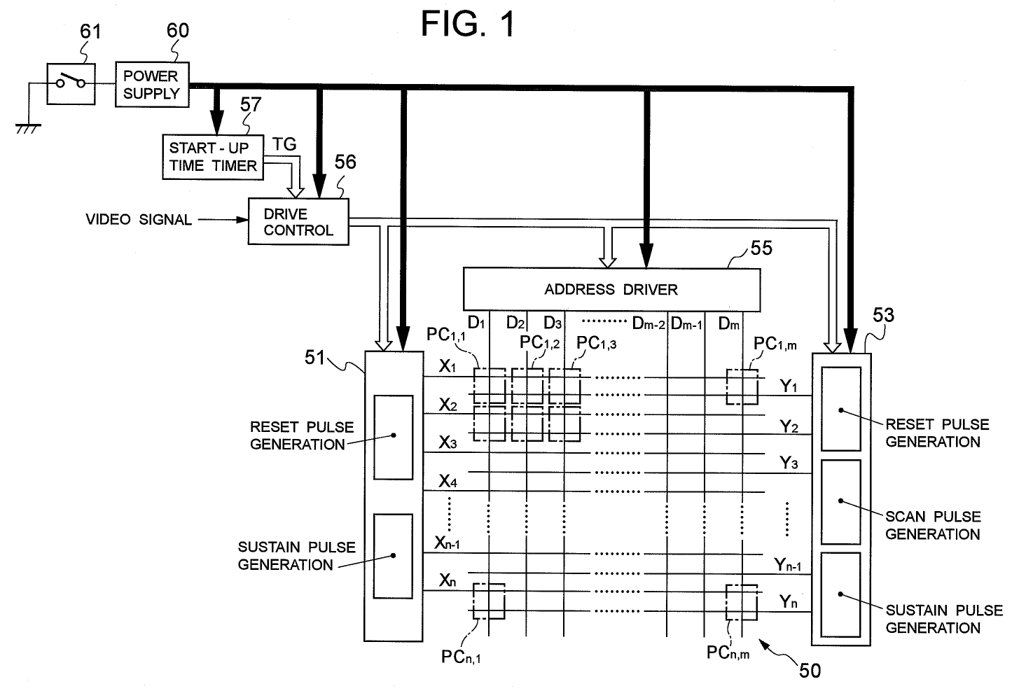

FIG. 1 is a diagram depicting a general configuration of a plasma display device according to the present invention.

As shown in FIG. 1, the plasma display device comprises a PDP 50 as a plasma display panel, an X electrode driver 51, a Y electrode driver 53, an address driver 55, a drive control circuit 56, a start-up time timer 57, a power supply circuit 60 for supplying power supply voltage to these various modules, and a power supply switch 61.

In the PDP 50 are formed column electrodes D₁ to Dₘ extended and arrayed in a longitudinal direction (vertical direction) of a two-dimensional display screen, and row electrodes X₁ to Xₙ and row electrodes Y₁ to Yₙ respectively extended and arrayed in a lateral direction (horizontal direction). Each of row electrode pairs (Y₁, X₁), (Y₂, X₂), (Y₃, X₃), . . . , (Yₙ, Xₙ) made up of row electrodes adjacent to each other serves as a first to n-th display line in the PDP 50. A discharge cell (display cell) PC, which acts as a pixel, is formed at an intersection of each of the display lines and each of the column electrodes D₁ to Dₘ (an area enclosed by the dashed line in FIG. 1). Namely, in the PDP 50 are arrayed in a matrix discharge cells PC_{1,1} to PC_{1,m} belonging to the first display line, discharge cells PC_{2,1} to PC_{2,m} belonging to the second display line, . . . , and discharge cells PC_{n,1} to PC_{n,m} belonging to the n-th display line.

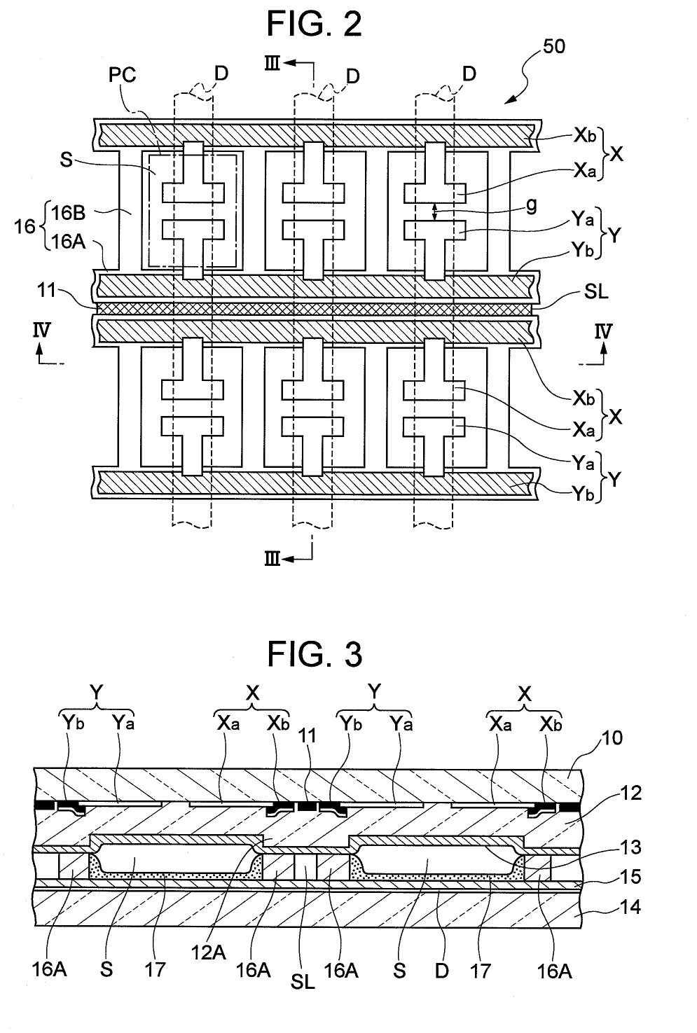

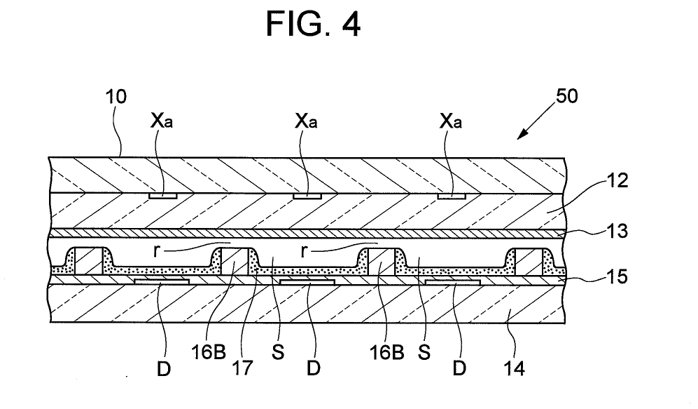

FIG. 2 is a front view schematically depicting an internal structure of the PDP 50 viewed from a display surface side. FIG. 2 shows only respective intersections of three of the column electrodes D which are adjacent to each other, and two of the display lines which are adjacent to each other. FIG. 3 is a cross-sectional view of the PDP 50 along a line III-III in FIG. 2, and FIG. 4 a cross-sectional view of the PDP 50 along a line IV-IV in FIG. 2.

As shown in FIG. 2, each row electrode X comprises a bus electrode Xb and a T-shaped transparent electrode Xa. The bus electrode Xb extends in a horizontal direction of the two-dimensional display screen. The T-shaped transparent electrode Xa is formed on the bus electrode Xb at a position corresponding to each discharge cell PC that is in contact with the bus electrode Xb. Each row electrode Y comprises a bus electrode Yb and a T-shaped transparent electrode Ya. The bus electrode Yb extends in the horizontal direction of the two-dimensional display screen. The T-shaped transparent electrode Ya is formed on the bus electrode Yb at a position corresponding to each discharge cell PC that is in contact with the bus electrode Yb. The transparent electrodes Xa and Ya are formed of a transparent conductive film such as ITO. The bus electrodes Xb and Yb are made of a metal film, for example. The row electrode X comprised of the transparent electrode Xa and the bus electrode Xb, and the row electrode Y comprised of the transparent electrode Ya and the bus electrode Yb are formed, as shown in FIG. 3, on a back surface of a front transparent substrate 10 whose front surface serves as a display surface of the PDP 50. The transparent electrodes Xa and Ya in each row electrode pair (X, Y) mutually extend toward the other row electrode of the pair. Wide top sides of the transparent electrodes Xa and Ya face each other with a discharge gap g1 in between. The discharge gap g1 has a predetermined width. A black or dark-colored light absorbing layer (light shielding layer) 11 is formed on the back surface of the front transparent substrate 10 between a row electrode pair (X, Y) and another row electrode pair (X, Y) which is adjacent thereto. The light absorbing layer extends in the horizontal direction of the two-dimensional display screen. Also, a dielectric layer 12 is formed on the back surface of the front transparent substrate 10 to cover the row electrode pair (X, Y). As shown in FIG. 3, a bulky dielectric layer 12A is formed on a back surface of the dielectric layer 12 (a surface opposite from the surface to which the row electrode pairs contact) at a portion corresponding to an area where the light absorbing layer 11 and bus electrodes Xb and Yb adjacent to this light absorbing layer 11 are formed.

A magnesium oxide layer 13 is formed on a surface of the dielectric layer 12 and the bulky dielectric layer 12A. The magnesium oxide layer 13 contains magnesium oxide crystals as a secondary electron emissive material. The secondary electron emissive material is excited by the irradiated electron beams and performs cathode luminescence (CL) light emission whose peak falls within the wavelength range of 200 to 300 nm, specifically within the wavelength range of 230 to 250 nm. (The magnesium oxide crystals will be hereinafter called CL light emissive MgO crystals.) These CL light emissive MgO crystals are obtained by performing vapor-phase oxidation of magnesium vapor which is generated by heating magnesium, and has, for example, a polycrystal structure where cubic crystals are fit into each other or a cubic monocrystal structure. The average particle size of a CL light emissive MgO crystal is 2000 angstrom or greater (the measurement result according to the BET method).

To form vapor-phase grown magnesium oxide monocrystals that have a large average particle size of 2000 angstrom or greater, the heating temperature needs to be raised when generating magnesium vapor. This makes a flame length longer in the reaction between magnesium and oxygen, and increases a temperature difference between the flame and the surroundings. Thus, the larger the particle size of the vapor-phase grown magnesium oxide monocrystal is, the more likely the monocrystal has an energy level corresponding to the peak wavelength of the above CL light emission (for example, about 235 nm, within the wavelength range of 230 to 250 nm).

When vapor-phase grown magnesium oxide monocrystals are generated by increasing, compared with a popular vapor-phase oxidation method, an amount of magnesium evaporated per unit time and a reaction area between magnesium and oxygen and thereby making the magnesium reacted with more oxygen, the magnesium oxide monocrystals have an energy level corresponding to the peak wavelength of the above CL light emission.

The magnesium oxide layer 13 is formed by attaching the CL light emissive MgO crystals onto the surface of the dielectric layer 12 by spraying or electrostatic coating. The magnesium oxide layer 13 may be formed by forming a thin-film magnesium oxide layer on the surface of the dielectric layer 12 by deposition or sputtering, and attaching CL light emissive MgO crystals thereon.

Each of column electrodes D is formed on a back substrate 14, which is disposed in parallel with the front transparent substrate 10, to extend in a direction perpendicular to the row electrode pair (X, Y) at a position facing the transparent electrodes Xa and Ya of each row electrode pair (X, Y). On the back substrate 14, a white column electrode protective layer 15 that coats the column electrode D is further formed. On the column electrode protective layer 15A, a partition 16 is formed. The partition 16 is formed into a ladder structure by a lateral partition 16A and a longitudinal partition 16B. The lateral partition 16A extends in the lateral direction of the two-dimensional display screen at a position corresponding to the bus electrodes Xb and Yb of each row electrode pair (X, Y). The longitudinal partition 16B extends in the longitudinal direction of the two-dimensional display screen at each intermediate position between adjacent column electrodes D. Furthermore, the ladder-structured partition 16 is formed for each display line of the PDP 50 as shown in FIG. 2. A clearance SL, as shown in FIG. 2, exists between the partitions 16 that are adjacent to each other. The ladder-structured partition 16 defines discharge cells PC, which respectively include an independent discharge space S and transparent electrodes Xa and Ya. Discharge gas containing xenon gas is sealed in the discharge space S. A portion between the discharge space S and the clearance SL in each discharge cell PC is closed, as shown in FIG. 3, by the magnesium oxide layer 13 that contacts the lateral partition 16A. On the other hand, as shown in FIG. 4, the longitudinal partition 16B does not contact the magnesium oxide layer 13 and a clearance r exists therebetween. In other words, the respective discharge spaces S of the discharge cells PC adjacent to each other in the lateral direction of the two-dimensional display screen is interconnected via the clearance r.

A phosphor layer 17 is formed in each discharge cell PC on side surfaces of the lateral partition 16A and the longitudinal partition 16B and a surface of the column electrode protective layer 15, such that the phosphor layer 17 completely covers all these surfaces. The phosphor layer 17 actually has three types of phosphors: one for red light emission, one for green light emission, and one for blue light emission.

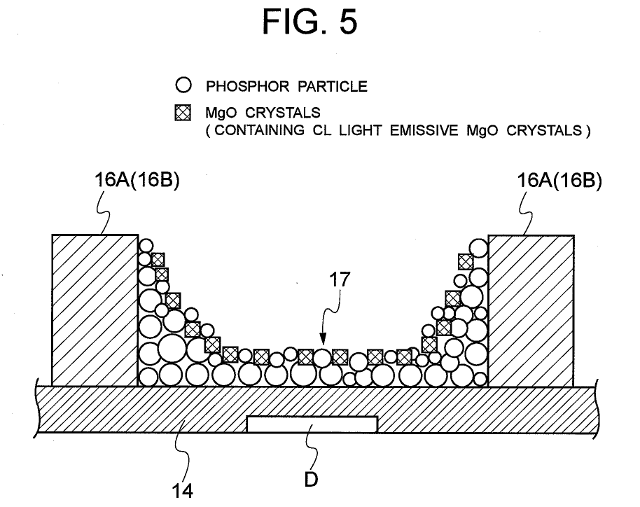

The phosphor layer 17 contains MgO crystals (including CL light emissive MgO crystals) as a secondary electron emissive material in the form shown in FIG. 5, for example. On a surface of the phosphor layer 17 that surrounds the discharge space S, that is, a surface that contacts the discharge space S, the MgO crystals are exposed from the phosphor layer 17 such that the MgO crystals come in contact with the discharge gas.

In other words, in the PDP 50, not only the magnesium oxide layer 13 formed on the front transparent substrate 10 in each discharge cell PC, but also the phosphor layer 17 formed on the back substrate 14 contains CL light emissive MgO crystals as a secondary electron emissive material.

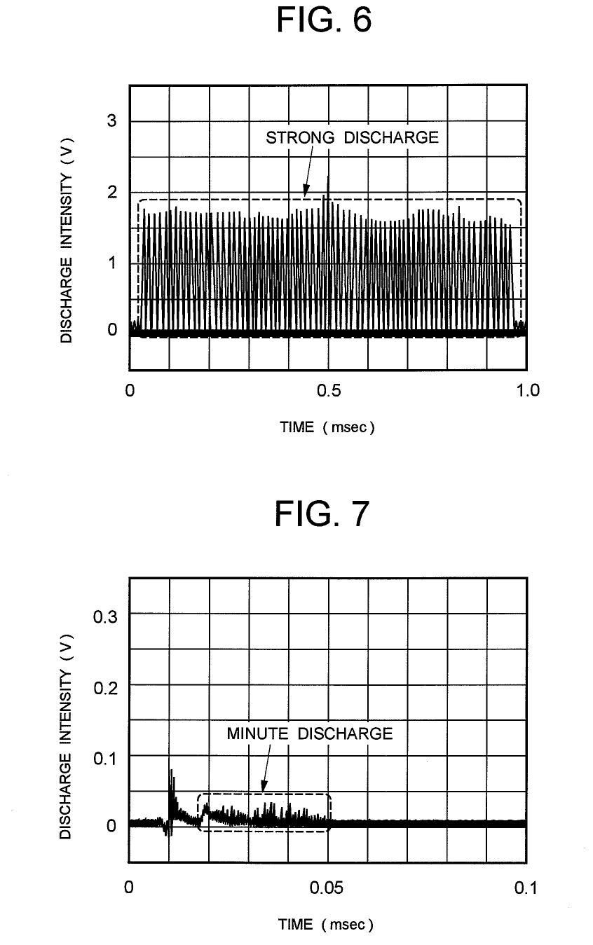

The functional effect of adopting this construction will be hereinafter described with reference to FIGS. 6 and 7.

FIG. 6 is a diagram depicting the transition of the discharge intensity discharge which is generated when a predetermined voltage is applied between row and column electrodes of a conventional PDP using the column electrode as a cathode, where CL light emissive MgO crystals are contained only in the magnesium oxide layer 13 out of the magnesium oxide layer 13 and the phosphor layer 17. FIG. 7, on the other hand, is a diagram depicting the transition of the discharge intensity in discharge which is generated when a predetermined voltage is applied between the row and column electrodes of a PDP according to the present invention using the column electrode as a cathode, where the CL light emissive MgO crystals are contained both in the magnesium oxide layer 13 and the phosphor layer 17.

As FIG. 6 shows, according to the conventional PDP, a relatively strong discharge continues for 1 millisecond (ms) or longer from a time point where discharge started. However, according to the PDP 50 of the present invention, faint discharge as shown in FIG. 7 ends within about 0.04 ms from a time point where discharge started. Thus, compared with a conventional PDP, a considerable decrease in discharge time lag and generation of faint discharge can be achieved by employing the configuration where both the magnesium oxide layer 13 and the phosphor layer 17 contain CL light emissive MgO crystals.

The X electrode driver 51 comprises a reset pulse generating circuit and a sustain pulse generating circuit. The reset pulse generating circuit of the X electrode driver 51 generates a reset pulse (to be described later) having a peak potential (pulse voltage) represented by a reset pulse generating signal supplied from the drive control circuit 56, and applies the pulse to the row electrode X of the PDP 50. The sustain pulse generating circuit of the X electrode driver 51 generates a sustain pulse (to be described later) having a peak potential (pulse voltage) represented by a sustain pulse generating signal supplied from the drive control circuit 56, and applies the pulse to the row electrode X of the PDP 50. The Y electrode driver 53 comprises a reset pulse generating circuit, a scan pulse generating circuit and a sustain pulse generating circuit. The reset pulse generating circuit of the Y electrode driver 53 generates a reset pulse (to be described later) having a peak potential (pulse voltage) represented by a reset pulse generating signal supplied from the drive control circuit 56, and applies the pulse to the row electrode Y of the PDP 50. The scan pulse generating circuit of the Y electrode driver 53 generates a scan pulse (to be described later) having a peak potential (pulse voltage) represented by a scan pulse generating signal supplied from the drive control circuit 56, and sequentially applies the pulse to the row electrode Y₁ to Yₙ of the PDP 50. The sustain pulse generating circuit of the Y electrode driver 53 generates a sustain pulse (to be described later) having a peak potential (pulse voltage) represented by a sustain pulse generating signal supplied from the drive control circuit 56, and applies the pulse to the row electrode Y of the PDP 50. The address driver 55 generates a pixel data pulse to be applied to the column electrode D of the PDP 50 in accordance with a pixel data pulse generating signal supplied from the drive control circuit 56.

The power supply circuit 60, upon switching of the power supply switch 61 from off-state to on-state, starts supplying various power supply voltages to the X electrode driver 51, Y electrode driver 53, address driver 55, drive control circuit 56, start-up time timer 57, and PDP 50. In other words, the switching of the power supply switch 61 from off-state to on-state turns the power on, to start the plasma display device shown in FIG. 1.

The start-up time timer 57 starts counting time from the time point where the supply of the power supply voltages from the power supply circuit 60 started, and supplies a start-up time signal TG, which represents the time elapsed, to the drive control circuit 56.

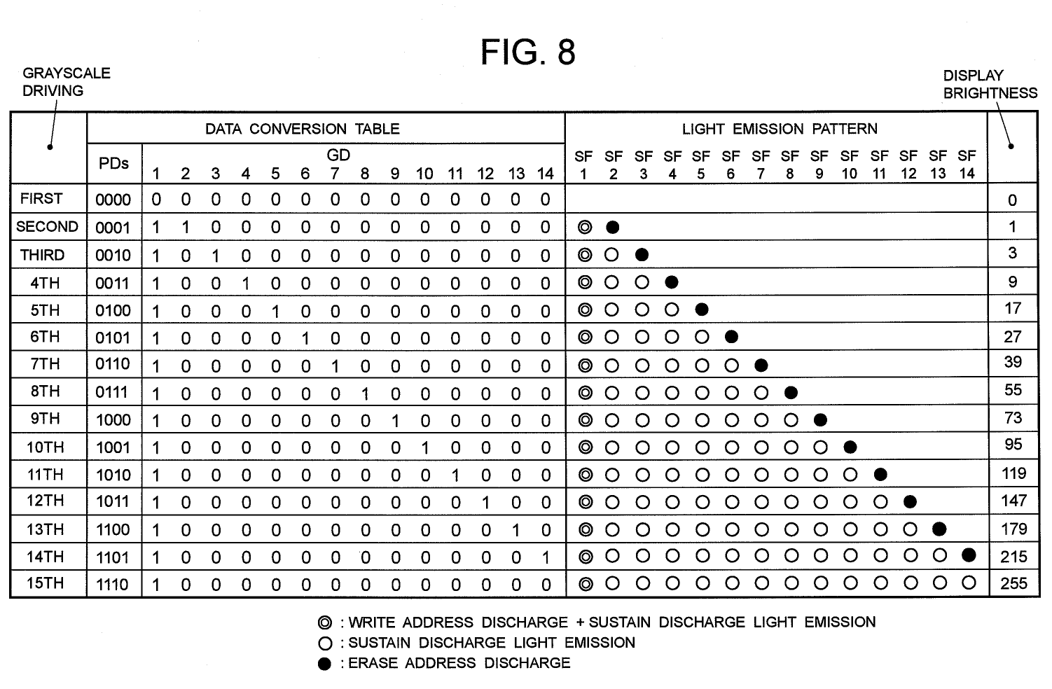

The drive control circuit 56 first converts an input video signal into 8-bit pixel data which represents all the brightness levels with 256 grayscales for each pixel, and performs a multi-grayscale processing on the pixel data, the multi-grayscale processing comprising error diffusion processing and dither processing. More specifically, in the error diffusion processing, the high order 6 bits of the pixel data is regarded as display data and the remaining low order 2 bits is regarded as error data. The error data of the pixel data corresponding to each peripheral pixel is weighed, added and reflected in the display data, and thereby 6-bit error diffusion processed pixel data is obtained. According to this error diffusion processing, the brightness of the low order 2 bits in the original pixel is represented by the peripheral pixels in a pseudo manner, and thus, a brightness grayscale equivalent to the 8-bit pixel data can be expressed by display data of 6 bits, which is less than 8 bits. Then, the drive control circuit 56 performs dither processing on the 6-bit error diffusion processed pixel data obtained through the error diffusion processing. In the dither processing, a plurality of adjacent pixels are regarded as one pixel unit. Dither coefficients comprising coefficient values different from one another are respectively assigned to the error diffusion processed pixel data corresponding to the respective pixels of the one pixel unit, and added thereto, and thereby dither added pixel data is obtained. By the addition of dither coefficients, brightness corresponding to 8 bits can be represented only by the high order 4 bits of the dither added pixel data when the image is viewed in pixel units. The drive control circuit 56 converts the high order 4 bits of the dither added pixel data into multi-grayscale pixel data PD_{S}, which represent, as shown in FIG. 8, the entire brightness levels (brightness levels 0 to 255) with fifteen grayscales. Then, the drive control circuit 56 converts the multi-grayscale pixel data PD_{S} into 14-bit pixel drive data GD according to the data conversion table shown in FIG. 8. The drive control circuit 56 associates the first to fourteenth bit of the pixel drive data GD respectively to the subfields SF1 to SF14 (to be described later), and supplies the bit digit corresponding to the subfield SF to the address driver 55 for one display line (m pixels) at a time simultaneously as pixel drive data bits.

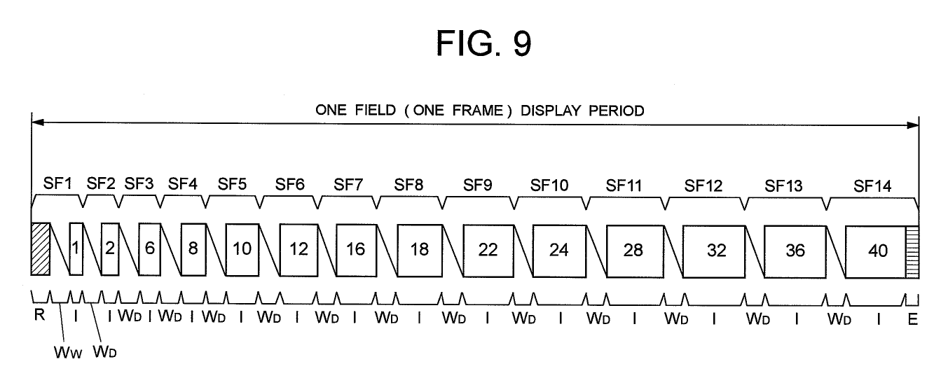

The drive control circuit 56 further supplies various control signals to the X electrode driver 51, Y electrode driver 53 and address driver 55 respectively for driving the PDP 50 having the above configuration according to the light emission drive sequence adopting the subfield method (sub-flame method) as shown in FIG. 9. In other words, the drive control circuit 56 supplies, as shown in FIG. 9, various control signals to “panel drivers, that is, the X electrode driver 51, Y electrode driver 53, and address driver 55” for sequentially performing driving according to a reset process R, selective write address process W_{W} and sustain process I in a first subfield SF1 in each one field (one frame) display period (hereinafter called unit display period). In the respective subfields SF2 to SF14, the drive control circuit 56 supplies various control signals to the panel driver for sequentially performing driving according to a selective erase address process W_{D} and sustain process I. After executing the sustain process I, the drive control circuit 56 supplies to the panel driver various control signals for sequentially performing driving according to an erase process E only in the last subfield SF14 of the unit display period.

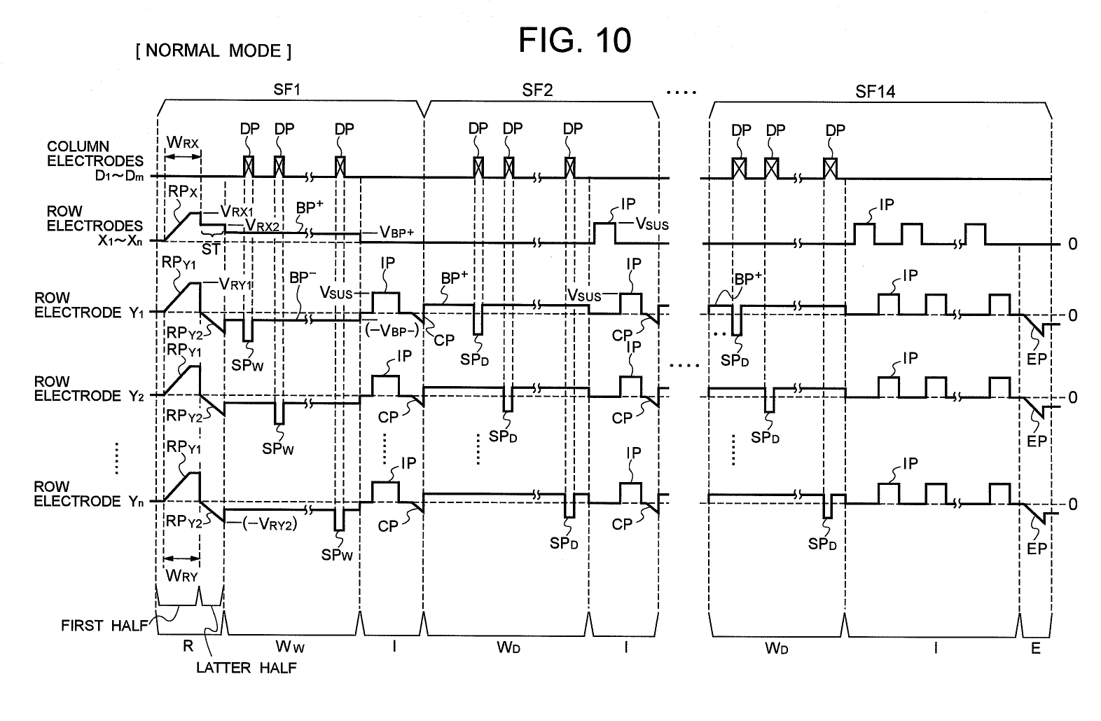

The panel drivers generate various drive pulses as shown in FIG. 10 according to various control signals supplied from the drive control circuit 56, and supplies the pulses to the column electrodes D and row electrodes X and Y of the PDP 50.

FIG. 10 shows only the operation in the first subfield SF1, subsequent subfield SF2 and the last subfield SF14 out of the subfields SF1 to SF14 shown in FIG. 9.

FIG. 10 illustrates drive pulses to be applied to the column electrodes D, and row electrodes X and Y of the PDP 50 when the drive control circuit 56 performs a control process according to a normal mode out of a start-up and normal mode.

In the first half of a reset process R in the subfield SF1, the Y electrode driver 53 applies a reset pulse RP_{Y1} to all the row electrodes Y1 to Yn. The reset pulse RP_{Y1} has a waveform whose potential transition at a leading edge with the lapse of time is gentle, compared with a sustain pulse to be described later. The reset pulse RP_{Y1} also has a peak potential V_{RY1} of positive polarity. During this time, the address driver 55 sets the column electrodes D₁ to Dₘ to the ground potential (0 volt) state. As the reset pulse RP_{Y1} is applied, first reset discharge is generated between the row electrodes Y and the column electrodes D in all the discharge cells PC. In other words, in the first half of the reset process R, a voltage is applied between the electrodes such that the anode side is the row electrode Y and the cathode side is the column electrode D. Thus, discharge for flowing current from the row electrode Y to the column electrode D (hereinafter called column side cathode discharge) is generated as the first reset discharge. By the first reset discharge, wall charges of negative polarity are formed near the row electrodes Y, and wall charges of positive polarity are formed near the column electrodes D in all of the discharge cells PC.

In the first half of the reset process R, the X electrode driver 51 applies a reset pulse RP, respectively to all the row electrodes X₁ to Xₙ. The reset pulse RP_{X} has the same polarity as that of the reset pulse RP_{Y1}, and also has a peak potential V_{RX1} of positive polarity that can prevent surface discharge generated between the row electrodes X and Y when the reset pulse RP_{Y1} is applied.

Next, in the latter half of the reset process R in the subfield SF1, the Y electrode driver 53 generates a reset pulse RP_{Y2}, and applies this to all the row electrodes Y₁ to Yₙ. As shown in FIG. 10, the reset pulse RP_{Y2} has a pulse waveform whose potential gradually falls with the lapse of time and reaches a peak potential of negative polarity (−V_{RY2}). Furthermore, in the latter half of the reset process R, the X electrode driver 51 applies a potential V_{RX2} respectively to all the row electrodes X₁ to Xₙ as a fixed potential for a falling step ST of the reset pulse RP_{X}. The potential V_{RX2} has positive polarity lower than that of the peak potential V_{RX1}. Upon the application of the reset pulse RP_{Y2} having negative polarity and the potential V_{RX2} having positive polarity, a second reset discharge is generated between the row electrodes X and Y in all the discharge cells PC. The negative polarity peak potential (−V_{RY2}) of the reset pulse RP_{Y2} and the positive polarity potential V_{RX2} are minimum potentials that can generate the second reset discharge without fail in response to the first reset discharge between the row electrodes X and Y, which are determined by taking account of the wall charges formed respectively near the row electrodes X and Y. The negative peak potential (−V_{RY2}) of the reset pulse RP_{Y2} is set at a potential higher than the peak potential of a negative polarity write scan pulse SP_{W} (to be described later), that is, a potential close to 0 volt. This is because, if the peak potential of the reset pulse RP_{Y2} is set to be lower than the peak potential of the write scan pulse SP_{W}, a strong discharge is generated between the row electrode Y and the column electrode D and a large amount of the wall charges formed near the column electrode D are erased, and thus making address discharge unstable in the selective write address process W_{W}. By the second reset discharge generated in the latter half of the reset process R, the wall charges formed respectively near the row electrodes X and Y in each discharge cell PC are erased, and all the discharge cells PC are initialized to OFF mode. Furthermore, upon the application of the reset pulse RP_{Y2}, a faint discharge is generated between the row electrode Y and the column electrode D in all the discharge cells PC. A part of the positive polarity wall charges formed near the column electrode D are erased by the discharge, and is adjusted to an amount which can generate selective write address discharge correctly in the selective write address process W_{W} to be described later.

Next, in the selective write address process W_{W} in the subfield SF1, the Y electrode driver 53 sequentially and alternatively applies the write scan pulse SP_{W} having a negative polarity peak potential to the respective row electrodes Y₁ to Yₙ while simultaneously applying to the row electrodes Y₁ to Yₙ a base pulse BP⁻ as shown in FIG. 10 having a negative polarity potential (−V_{BP-}). During this time, the X electrode driver 51 applies to the row electrodes X₁ to Xₙ respectively a base pulse BP⁺ having a positive polarity peak potential V_{RP+} lower than the potential V_{RX2}. The respective peak potentials of the base pulses BP− and BP+ are set to potentials such that the voltage between the row electrodes X and Y becomes lower than a discharge start voltage of the discharge cell PC in a period when the write scan pulse SP_{W} is not being applied.

Furthermore, in the selective write address process W_{W}, the address driver 55 first generates a pixel data pulse DP corresponding to the logic level of the pixel drive data bit corresponding to the subfield SF1. For example, when a pixel drive data bit with a logic level 1 for setting the discharge cell PC to ON mode is supplied, the address driver 55 generates a pixel data pulse DP having a positive polarity peak potential. For a pixel drive data bit with a logic level 0 for setting the discharge cell PC to OFF mode, on the other hand, the address driver 55 generates a low voltage (0 volt) pixel data pulse DP. Then, the address driver 55 applies the pixel data pulse DP to the column electrodes D₁ to Dₘ in synchronization with the application timing of each write scan pulse SP_{W} for one display line (m pixels) at a time simultaneously. In this case, at the same time as the application of this write scan pulse SP_{W}, selective write address discharge is generated between the column electrode D and the row electrode Y in the discharge cell PC where the high voltage pixel data pulse DP for setting the discharge cell to ON mode is applied. Immediately after this selective write address discharge, faint discharge is also generated between the row electrodes X and Y in the discharge cell PC. In other words, after the write scan pulse SP_{W} is applied, a voltage is applied between the row electrodes X and Y according to the base pulses BP− and BP+. However, this voltage is set to a voltage lower than the discharge start voltage of each discharge cell PC. Thus, discharge is not generated in the discharge cell PC by the application of this voltage alone. If the selective write address discharge is generated, however, discharge is generated between the row electrodes X and Y, induced by this selective write address discharge, only by the voltage applied based on the base pulse BP⁻ and base pulse BP⁺. By this discharge and the selective write address discharge, the discharge cell PC is set to ON mode, where wall charges of positive polarity are formed near the row electrode Y, wall charges of negative polarity are formed near the row electrode X, and wall charges of negative polarity are formed near the column electrode D, respectively. On the other hand, the selective write address discharge is not generated between the column electrode D and the row electrode Y of the discharge cell PC where a low voltage (0 volt) pixel data pulse DP for setting the discharge cell to OFF mode is applied at the same time as the write scan pulse SP_{W}. Consequently, this discharge cell PC maintains the immediately preceding state, that is, the state of OFF mode initialized in the reset process R.

Then, in the sustain process I in the subfield SF1, the Y electrode driver 53 generates only one pulse of a sustain pulse IP having a positive polarity peak potential V_{SUS}, and simultaneously applies this to each of the row electrodes Y₁ to Yₙ. During this time, the X electrode driver 51 sets the row electrodes X₁ to Xₙ to the ground potential (0 volt) state. The address driver 55 sets the column electrodes D₁ to Dₘ to the ground potential (0 volt) state. As the sustain pulse IP is applied, sustain discharge is generated between the row electrodes X and Y in the discharge cell PC set to ON mode. Along with this sustain discharge, light emitted from the phosphor layer 17 is irradiated outside through the front transparent substrate 10, and thereby one time of display emission is performed according to the brightness weight of the subfield SF1. As this sustain pulse IP is applied, discharge is also generated between the row electrode Y and the column electrode D in the discharge cell PC set to ON mode. By this discharge and the sustain discharge, wall charges of negative polarity are formed near the row electrode Y, and wall charges of positive polarity are formed near the row electrode X and column electrode D, respectively in the discharge cell PC. After the sustain pulse IP is applied, the Y electrode driver 53 applies a wall charge adjustment pulse CP to the row electrodes Y₁ to Yₙ. As shown in FIG. 10, the wall charge adjustment pulse CP has a negative polarity peak potential whose potential transition at the leading edge with the lapse of time is gentle. As this wall charge adjustment pulse CP is applied, faint erase discharge is generated in the discharge cell PC where the above sustain discharge is generated, and a part of the wall charges formed inside the discharge cell is erased. Thus, the amount of wall charges inside the discharge cell PC is adjusted to an amount that can generate the selective erase address discharge correctly in the next selective erase address process W_{D}.

Then, in the selective erase address process W_{D} in each of the subfield SF2 to SF14, the Y electrode driver 53 sequentially and alternatively applies an erase scan pulse SP_{D} to the respective row electrode Y₁ to Yₙ while applying the base pulse BP⁺ to the respective row electrodes Y₁ to Yₙ. The erase scan pulse SP_{D} has a negative polarity peak potential as shown in FIG. 10. The base pulse BP⁺ has a positive polarity peak potential V_{BP+}. The peak potential of the base pulse BP⁺is set to a potential that can prevent erroneous discharge between the row electrodes X and Y while the selective erase address process W_{D} is being executed. Also, while the selective erase address process W_{D} is being executed, the X electrode driver 51 sets each row electrode X₁ to Xₙ to the ground potential (0 volt). In this selective erase address process W_{D}, the address driver 55 first converts a pixel drive data bit corresponding to the subfield SF into a pixel data pulse DP corresponding to the logic level thereof. For example, when the pixel drive data bit with the logic level 1 for shifting the discharge cell PC from ON mode to OFF mode is supplied, the address driver 55 converts this into a pixel data pulse DP having a positive polarity peak potential. When a pixel drive data bit with the logic level 0 for maintaining the current state of the discharge cell PC is supplied, on the other hand, the address driver 55 converts this into a low voltage (0 volt) pixel data pulse DP. The address driver 55 then applies the pixel data pulse DP to the column electrodes D₁ to Dₘ in synchronization with the application timing of each erase scan pulse SP_{D} for one display line (m pixels) at a time simultaneously. In this case, selective erase address discharge is generated between the column electrode D and the row electrode Y in the discharge cell PC where the high voltage pixel data pulse DP was applied at the same time as the erase scan pulse SP_{D}. By this selective erase address discharge, this discharge cell PC is set to OFF mode, where wall charges of positive polarity are formed near the row electrodes X and Y, and wall charges of negative polarity are formed near the column electrode D. The above selective erase address discharge is not generated between the column electrode D and the row electrode Y in the discharge cell PC where the low voltage (0 volt) pixel data pulse DP is applied at the same time as the erase scan pulse SP_{D}. Therefore, this discharge cell PC maintains the immediately preceding state (ON mode or OFF mode).

In the sustain process I in each subfield SF2 to SF14, the X electrode driver 51 and the Y electrode driver 53 apply the sustain pulse IP having a positive polarity peak potential V_{SUS} to each of the row electrodes X₁ to Xₙ and Y₁ to Yₙ (alternately to the row electrodes X and Y) repeatedly for the number of times (even number of times) corresponding to the brightness weight of the subfield as shown in FIG. 10. Each time this sustain pulse IP is applied, sustain discharge is generated between the row electrodes X and Y in the discharge cell PC set to ON mode. The light emitted from the phosphor layer 17 is irradiated outside via the front transparent substrate 10 along with this sustain discharge, and thereby the display emission is performed for the number of times according to the brightness weight of the subfield SF. In this case, wall charges of negative polarity are formed near the row electrode Y, and wall charges of positive polarity are formed near the row electrode X and the column electrode D, respectively, in the discharge cell PC where the sustain discharge is generated according to a sustain pulse IP applied last in each sustain process I in the subfields SF2 to SF14. After this last sustain pulse IP is applied, the Y electrode driver 53 applies to the row electrodes Y₁ to Yₙ the wall charge adjustment pulse CP having a negative polarity peak potential. As shown in FIG. 10, the potential transition of the pulse at a leading edge with the lapse of time is gentle. As this wall charge adjustment pulse CP is applied, faint erase discharge is generated in the discharge cell PC where the above sustain discharge is generated. A part of the wall charges formed inside the discharge cell is erased. Thus, the amount of the wall charges in the discharge cell PC is adjusted to an amount that can generate the selective erase address discharge correctly in the next selective erase address process W_{D}.

At the end of the last subfield SF14, the Y electrode driver 53 applies an erase pulse EP having a negative polarity peak potential to all the row electrodes Y₁ to Yₙ. Upon the application of this erase pulse EP, erase discharge is generated only in the discharge cell PC in ON mode. By this erase discharge, the discharge cell PC in ON mode shifts to OFF mode.

The above driving is executed according to the fifteen types of pixel drive data GD shown in FIG. 8. According to this drive, as shown in FIG. 8, write address discharge is first generated (indicated by dual circles) in each pixel cell PC in the first subfield SF1, except in the case of representing a brightness level 0 (first grayscale), and this pixel cell PC is set to ON mode. Then, the selective erase address discharge is generated (indicated by a solid black circle) only in the selective erase address process W_{D} of one subfield out of the subfields SF2 to SF14, and the discharge cell PC is set to OFF mode. In other words, each discharge cell PC is set to ON mode in continuous subfields corresponding to the half tone brightness to be represented, and repeatedly generates emission (indicated by a circle) accompanying the sustain discharge, the number of times assigned to each of these subfields. In this case, brightness corresponding to the total number of sustain discharge generated in one field (or one frame) of a display period is visually recognized. Therefore, according to the fifteen types of the light emission patterns generated by the first to fifteenth grayscale driving as shown in FIG. 8, fifteen grayscales of half tone brightness can be represented corresponding to the total number sustain discharges generated in each subfield indicated by a circle.

According to this driving, areas where the light emission pattern (ON state, OFF state) are inverted from each other do not coexist in one screen in a unit display period. Thus, a false contour that is generated in such a state can be prevented.

In the above driving, the reset discharge for initializing all the discharge cells PC to OFF mode state is first generated in the first subfield SF1. Then, the selective write address discharge is generated for shifting the discharge cells PC in OFF mode state to ON mode state. After that, in one subfield out of the subfields SF2 to SF14 which follow SF1, the selective erase address discharge is generated for shifting the discharge cells PC in ON mode state to OFF mode state. Thus, driving according to the selective erase address method is executed. Therefore, when black display (the brightness level 0) is performed by this driving, the discharge generated throughout a unit display period is only the reset discharge generated in the first subfield SF1. In other words, the number of discharges generated throughout a unit display period decreases compared with the case of generating the reset discharge for initializing all the discharge cells PC to ON mode state in the first subfield SF1 and then generating the selective erase address discharge for shifting the discharge cells PC to OFF mode state. Consequently, contrast when a dark image is displayed, that is, so-called dark contrast, can be improved.

Furthermore, the discharge time lag can be drastically cut down and the generation of faint discharge becomes possible by adopting a construction as shown in FIGS. 2 to 5 as the PDP 50, wherein both the magnesium oxide layer 13 and the phosphor layer 17 include CL light emissive MgO crystals. This enables assured generation of faint reset discharge. The luminescence accompanying reset discharge unrelated to displaying an image can be thus restrained, thereby making it possible to improve contrast of an image, in particular, dark contrast when a dark image is displayed.

Here, the use of magnesium oxide causes discharge in the respective display cells to become dispersed for a predetermined period of time after power-on, for example, about a minute, and thus causing distortion in the displayed images. As described above, this is because the MgO crystals provided in the discharge cell have already absorbed, before power-on, gas contained within the discharge space of the discharge cell that does not contribute to discharge (hereinafter called garbage gas). If the MgO crystals contain the garbage gas, the discharge start voltage of the discharge cell becomes higher than a normal value, and the discharge characteristics of the respective discharge cells become widely varied. The garbage gas contained in the MgO crystals is gradually discharged into the discharge space after discharge starts. The displayed images are therefore distorted for about a minute, until all the garbage gas contained in the MgO crystals is discharged.

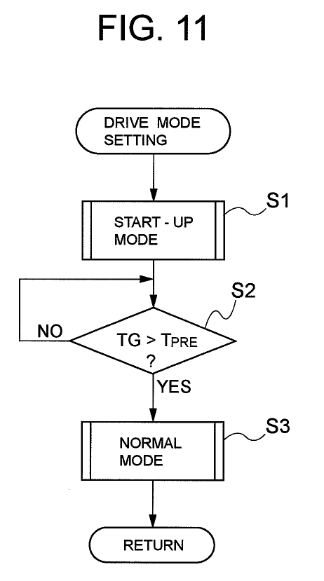

The drive control circuit 56 first executes drive mode setting process shown in FIG. 11 when the supply of a source voltage begins upon power-on from the power supply circuit 60.

In FIG. 11, the drive control circuit 56 first supplies to the panel drivers various control signals for driving the PDP 50 in start-up mode (step S1). After executing the step 1, the drive control circuit 56 repeatedly executes a step of determining whether or not a start-up time signal TG, which represents the time elapsed from power-on to the present, is greater than a predetermined period of time T_{PRE} until the signal TG is determined to be greater (step S2). In other words, in the step 2, it is determined whether or not the time elapsed from power-on to the present has exceeded the predetermined period of time T_{PRE}, that is, a time needed for the MgO crystals provided within the discharge cell to complete discharging all the garbage gas (for example, a minute). When the time elapsed from power-on to the present is determined in the step 2 to be greater than the predetermined period of time T_{PRE}, the drive control circuit 56 controls the panel drivers to switch the drive mode for the PDP 50 from the start-up mode to the normal mode (step S3). By the execution of the step 3, various drive pulses are applied to the PDP 50 according to the patterns of the normal mode as shown in FIG. 10.

As described above, in the plasma display device shown in FIG. 1, the driving is performed according to the normal mode shown in FIG. 10 after the passage of a predetermined period of time (for example, a minute) since power-on, and during start-up time the driving is performed according to the start-up mode to be described hereinbelow.

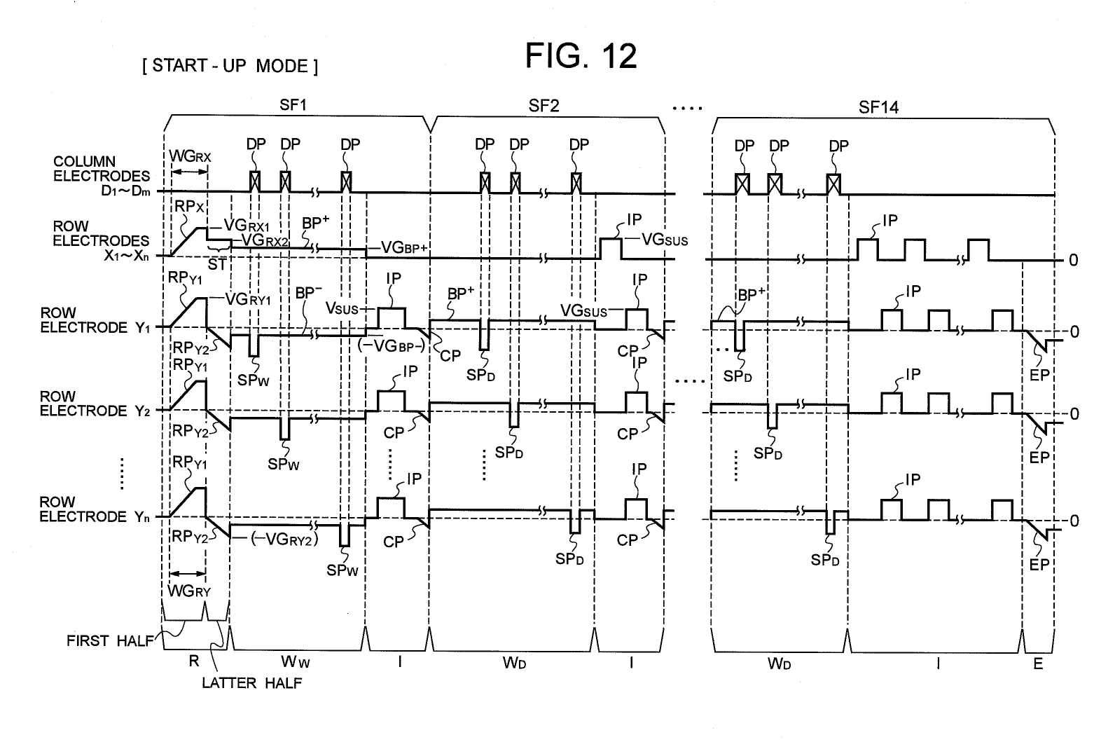

In the start-up mode, the drive control circuit 56 controls the panel drivers according to a light emission drive sequence shown in FIG. 9 to apply various drive pulses as shown in FIG. 12 to the column electrode D, row electrodes X and Y of the PDP 50.

In this case, various drive pulses (PR_{X}, PR_{Y1}, PR_{Y2}, DP, BP⁺, BP⁻, SP_{W}, IP, CP, SP_{D}, EP) shown in FIG. 12 and various operations performed in response thereto are the same as those in the case of the normal mode shown in FIG. 10.

However, the pulse waveforms of the various drive pulses such as reset pulses PR_{X}, PR_{Y1}, and PR_{Y2}, sustain pulse IP, base pulses BP⁺ and BP⁻ are different in the start-up mode from those in the normal mode.

To be more specific, the following potentials and pulse widths are adopted in the start-up mode:

(1) a potential VG_{RX1} lower than the potential V_{RX1} as the positive polarity peak potential of the reset pulse RP_{X};

(2) a potential VG_{RY1} higher than the potential V_{RY1} as the positive polarity peak potential of the reset pulse RP_{Y1};

(3) a potential (−VG_{RY2}) lower than the potential (−V_{RY2}) as the negative polarity peak potential of the reset pulse RP_{Y2};

(4) a potential VG_{RX2} higher than the potential V_{RX2} as a potential for a falling step ST of reset pulse RP_{X};

(5) a potential (−VG_{BP-}) lower than the potential (−V_{BP-}) as the peak potential of the base pulse BP⁻;

(6) a potential VG_{BP+} higher than the potential V_{BP+} as the peak potential of the base pulse BP⁺;

(7) a potential VG_{SUS} higher than the potential V_{SUS} as the positive polarity peak potential of the sustain pulse IP;

(8) a pulse width WG_{RY} wider than the pulse width W_{RY} as the pulse width of the reset pulse RP_{Y1}; and

(9) a pulse width WG_{RX} narrower than the pulse width W_{RX} as the pulse width of the reset pulse RP_{X}.

Any one of the above (1)-(9) or a combination of at least two out of the above (1)-(9) may be adopted.

That is, in the first half of the reset process R in the start-up mode, the positive polarity peak potential of the reset pulse RP_{Y1} is set to a potential VG_{RY1} higher than the potential V_{RY1} in the normal mode. The pulse width thereof is set to a pulse width WG_{RY} wider than the pulse width W_{RY} in the normal mode. The positive polarity peak potential of reset pulse RP_{X} is set to a potential VG_{RX1} lower than the potential V_{RX1} in the normal mode. Thus, the voltage applied between the row electrodes X and Y becomes higher than in the normal mode and the generation of the column side cathode discharge between the row electrode Y and the column electrode D becomes easy. The greater the voltage (field intensity) applied between the row electrodes X and Y is, the more easy the generation of the column side cathode discharge between the row electrode Y and the column electrode D becomes induced by the electric field. However, if the voltage is excessively increased, there is a possibility that discharge may be also generated between the row electrodes X and Y, and therefore, a voltage that does not generate such discharge is applied.

In the latter half of the reset process R in the start-up mode, the negative polarity peak potential of the reset pulse RP_{Y2} is set to a potential (−VG_{RY2}) lower than the potential (−V_{RY2}) in the normal mode. Thus, the voltages applied between the row electrodes X and Y and between the row electrode Y and the column electrode D become higher than in the normal mode, and the generation of the discharge between the row electrodes X and Y, and the row electrode Y and the column electrode D becomes easy.

In the selective write address process W_{W} in the start-up mode, the peak potential of the base pulse BP⁻ is set to a potential (−VG_{BP-}) lower than the potential (−V_{BP-}) in the normal mode. The peak potential of the base pulse BP⁺ is set to a potential VG_{BP+} higher than the potential V_{BP+} in the normal mode. Thus, the voltages applied between the row electrodes X and Y, and the row electrode Y and the column electrode D become higher than in the normal mode, and the generation of the write address discharge between the row electrodes X and Y, and the row electrode Y and the column electrode D becomes easy.

In the sustain process I in the start-up mode, the positive polarity peak potential of the sustain pulse IP is set to a potential VG_{SUS} higher than the potential V_{SUS} in the normal mode. Therefore, the voltage applied between the row electrodes X and Y in the start-up mode become higher than in the normal mode, and the generation of the sustain discharge between the row electrodes X and Y becomes easy. In the only once sustain discharge in the sustain process I in the first subfield SF1, the column side cathode discharge is also generated between the row electrode Y and the column electrode D. In this case, the voltage is increased between the row electrode Y and the column electrode D, and the generation of this column side cathode discharge also becomes easy.

In other words, in the start-up mode, the positive polarity peak potentials of the various drive pulses are set to be higher than in the normal mode, and the negative polarity peak potentials lower than in the normal mode, and thereby the voltages applied between the row electrodes X and Y, and the row electrode Y and column electrode D are increased to ensure the generation of discharge.

Consequently, the generation of the various discharge can be ensured even if the discharge characteristics of the respective discharge cells are varied for a predetermined start-up period of time (for example, a minute) from power-on due to the garbage gas contained in the MgO crystals provided within the discharge cells for the improvement of dark contrast. Accordingly, deterioration in the image quality can be suppressed at power-on while improving dark contrast.

After a lapse of the start-up time, the driving is shifted to the normal mode. Faint reset discharge is generated in the reset process R, and thereby dark contrast is improved. The power consumption can be also reduced.

In particular, when the phosphor layer contains MgO crystals as a secondary electron emissive material as in the PDP 50, it means that the phosphor layer contains a secondary electron emissive material that is prone to absorb garbage gas. Then, there arises a problem that the discharge characteristics become unstable during the start-up time compared with a PDP that does not contain MgO crystals. This problem can be resolved by adopting the above constitution.

In a PDP that contains CL light emissive MgO crystals in a phosphor layer, reset discharge is very faint. The effect of the dispersion in the discharge generated in the respective cells is therefore more serious. In other words, there arises a problem that even small variations in the discharge characteristics can become the cause of a discharge cell wherein no reset discharge is generated. Such a problem, too, can be resolved by adopting the constitution of the present embodiment.

In the plasma display device shown in FIG. 1, since the peak potentials of the drive pulses are set to be different in the start-up mode and in the normal mode, power sources are provided for each of the modes to generate the peak potentials of the drive pulses. For example, a first power source and a second power source are provided within the power supply circuit 60 as power sources for generating the positive polarity peak potential of the reset pulse PR_{Y1}. The first power source generates the potential V_{RY1} for the normal mode. The second power source generates the potential VG_{RY1} for the start-up mode. The Y electrode driver 53 alternatively uses the potential VG_{RY1} generated by the second power source for the start-up mode or the potential V_{RY1} generated by the first power source for the normal mode, and thereby generates the peak potential of the reset pulse PR_{Y1}.

However, in order to generate this reset pulse PR_{Y1}, not only the positive polarity peak potential VG_{RY1} for the start-up mode but also the reset pulse PR_{Y1} having the positive polarity peak potential V_{RY1} for the normal mode may be generated, by using only the second power source out of the first and second power sources, by controlling the rising period of the reset pulse PR_{Y1}.

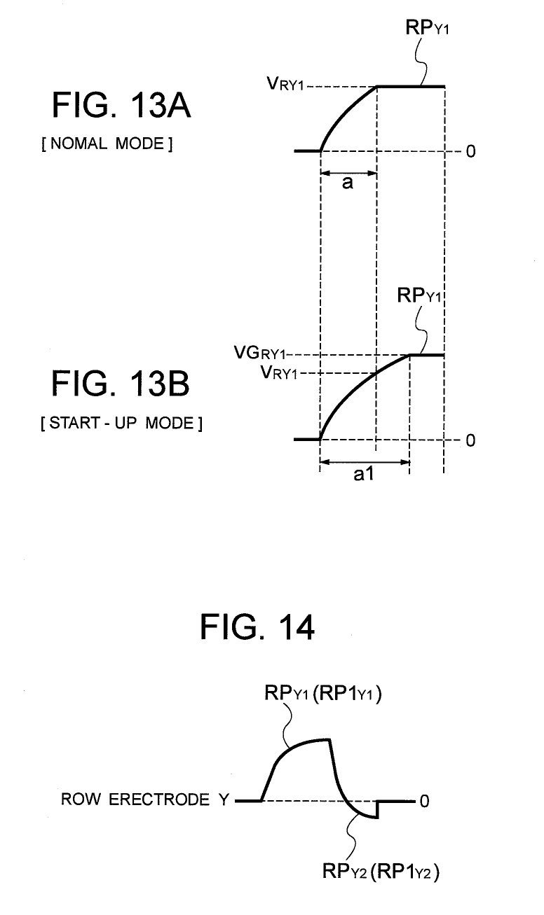

In the normal mode, for example, the Y electrode driver 53 applies, as shown in FIG. 13(A), to the Y electrode the potential VG_{RY1} generated by the second power source during a time period a. Thus, the load capacitance parasitic between the row electrodes X and Y of the PDP 50 is charged, and the potential of the Y electrode gradually rises with a lapse of time, as shown in FIG. 13(A), from 0 volt. The potential of the Y electrode reaches the potential V_{RY1} after the passage of the time period a since the potential began to rise. The Y electrode driver 53 sets the Y electrode in a high impedance state at a time point when the time period a has passed, and thereby the row electrode Y maintains the potential state at the time point when the time period a has passed. This potential state becomes, as shown in FIG. 13(A), the positive polarity peak potential V_{RY1} of the reset pulse PR_{Y1} in the normal mode.

In the start-up mode, on the other hand, the Y electrode driver 53 applies to the Y electrode the potential VG_{RY1} generated by the second power source during a time period a1, which is longer than the time period a, as shown in FIG. 13(B). Thus, the load capacitance parasitic between the row electrodes X and Y of the PDP 50 is charged, and the potential of the Y electrode gradually rises with the lapse of time, as shown in FIG. 13(B), from 0 volt. The potential of the Y electrode reaches the potential VG_{RY1} after the passage of the time period a1 since the potential began to rise. The Y electrode driver 53 sets the Y electrode in a high impedance state at a time point when the time period a1 has passed, and thereby the row electrode Y maintains the potential state at the time point when the time period a1 has passed. This potential state becomes, as shown in FIG. 13(B), the positive polarity peak potential VG_{RY1} of the reset pulse PR_{Y1} in the start-up mode.

It should be noted that the waveform of the reset pulse PR_{Y1} is not limited to those shown in FIG. 10 and 12. It may be such a waveform, for example, as shown in FIG. 14 whose slope of voltage transition gradually changes with the lapse of time. Furthermore, although in the reset process R shown in FIGS. 10 and 12, the reset discharge is generated simultaneously in all of the discharge cells, the discharge may be performed in respective discharge cell blocks which respectively comprises a plurality of discharge cells such that the discharge may be generated in a way dispersed on the time axis.

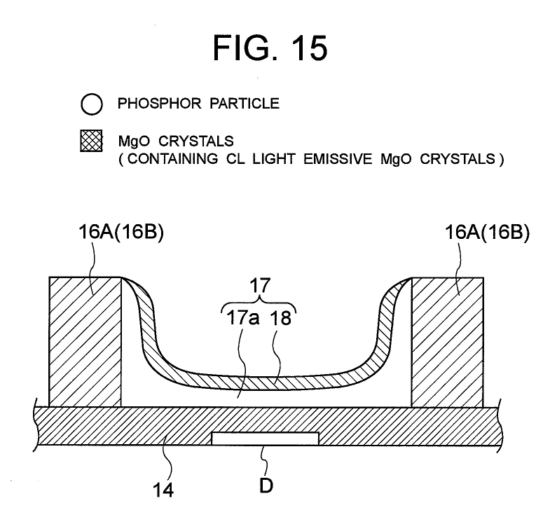

Also, although in the embodiment shown in FIG. 5 the MgO crystals are contained in the phosphor layer 17 provided on the side of the back substrate 14 of the PDP 50, the phosphor layer 17 may be formed, as shown in FIG. 15, by layering a phosphor particle layer 17a made of phosphor particles and a secondary electron emissive layer 18 made of a secondary electron emissive material. The secondary electron emissive layer 18 may formed by spreading crystals made of the secondary electron emissive material (for example, CL light emissive MgO crystals) or by forming a thin film of the secondary electron emissive material, over the surface of the phosphor particle layer 17a.

### Embodiment 2

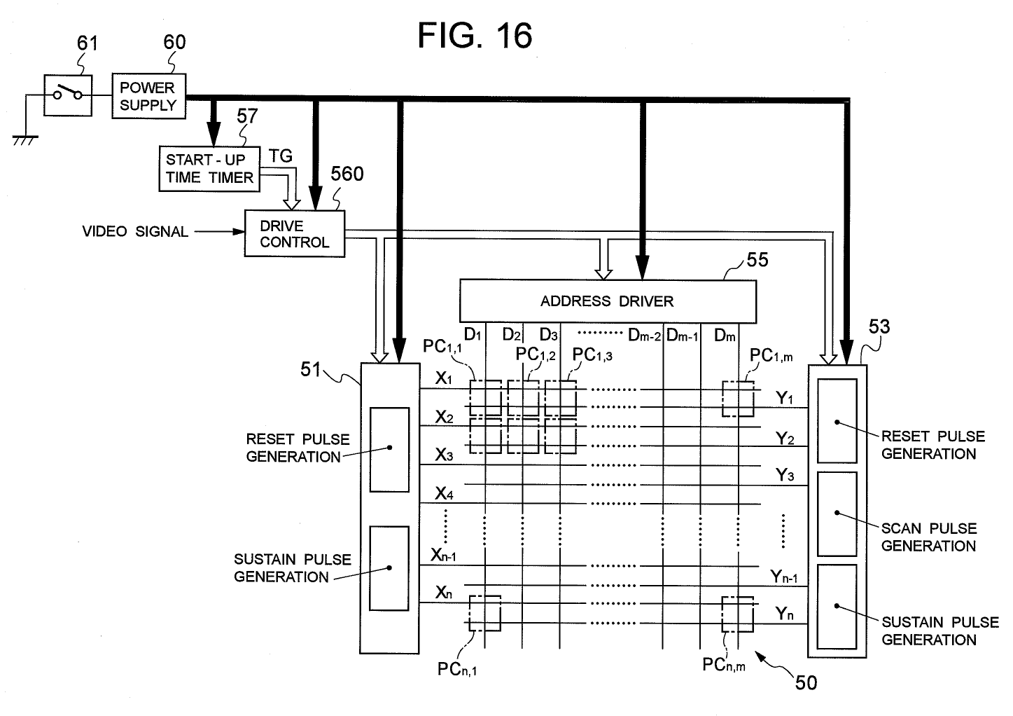

FIG. 16 shows another configuration of the plasma display device according to the present invention.

A PDP 50 of the plasma display device shown in FIG. 16 is the same as the PDP 50 of the plasma display device shown in FIG. 1, and has the same construction as shown in FIGS. 2-5 and 15. Moreover, an X electrode driver 51, a Y electrode driver 53, an address driver 55, a start-up time timer 57, a power supply circuit 60, and a power supply switch 61 of the plasma display device shown in FIG. 16 respectively perform the same operation as those shown in FIG. 1. Only the drive method for driving the PDP 50 performed by a drive control circuit 560, the X electrode driver 51, the Y electrode driver 53, and the address driver 55 is different from the plasma display device shown in FIG. 1.

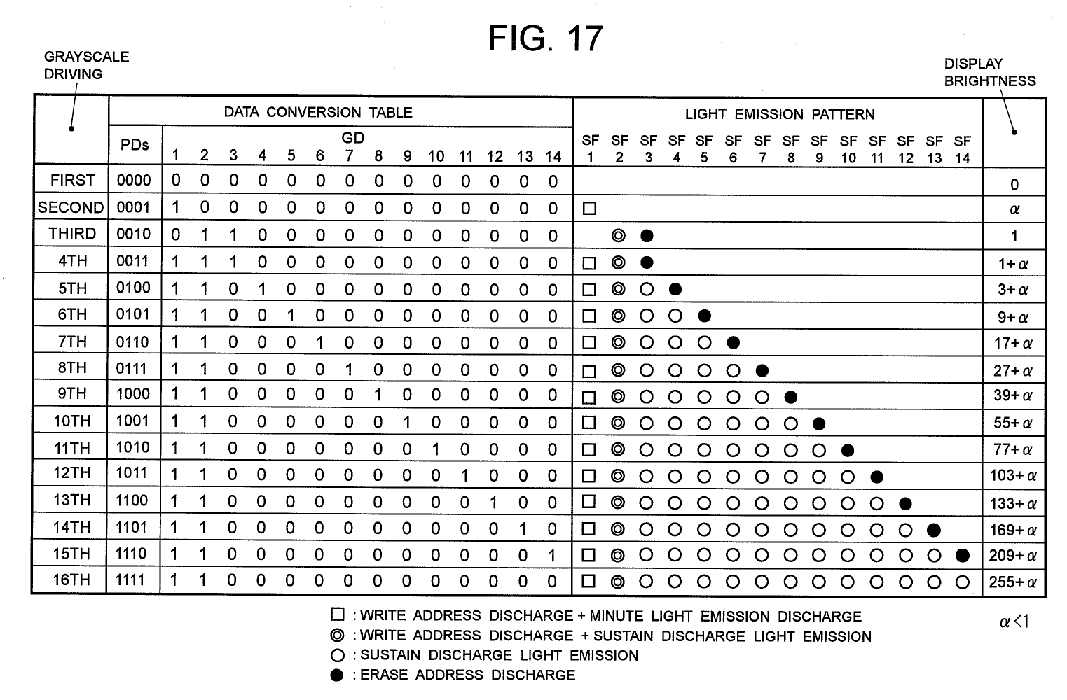

The drive control circuit 560 shown in FIG. 16 first converts an input video signal into 8-bit pixel data which represents all the brightness levels with 256 grayscales for each pixel, and performs a multi-grayscale processing on the pixel data, the multi-grayscale processing comprising error diffusion processing and dither processing. This multi-grayscale processing is the same as the processing performed in the drive control circuit 56 already described. In other words, by this multi-grayscale processing, the drive control circuit 560 divides the entire brightness range into fifteen levels and obtains 4-bit multi-grayscale pixel data PDs represents the brightness level thereof. The drive control circuit 560 then converts the multi-grayscale pixel data PDs into 14-bit pixel drive data GD according to a data conversion table shown in FIG. 17.

The drive control circuit 560 associates the first to fourteenth bit of the pixel drive data GD respectively to the subfields SF1 to SF14, and supplies to the address driver 55 the bit digit corresponding to the subfield SF as the pixel drive data bits for one display line (m pixels) at a time simultaneously.

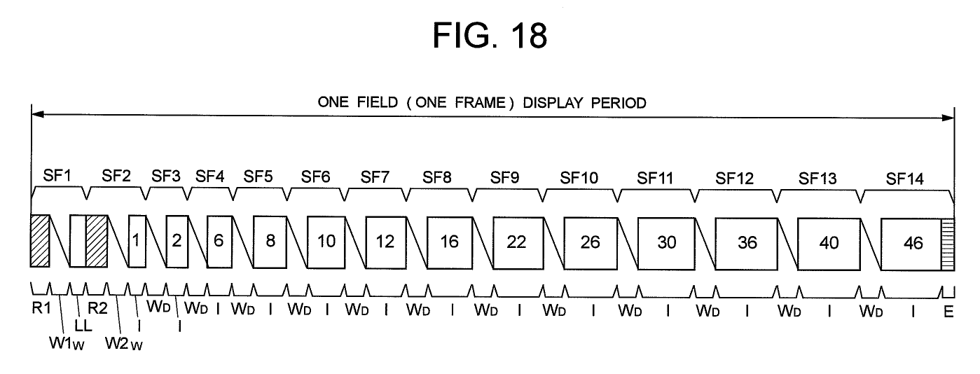

The drive control circuit 560 further supplies various control signals to the X electrode driver 51, the Y electrode driver 53, and the address driver 55 respectively. The control signals are used for driving the PDP 50 having the above configuration according to the light emission drive sequence as shown in FIG. 18. In other words, in a first subfield SF1 in one field (one frame) of a display period, the drive control circuit 560 supplies to the panel drivers (the X electrode driver 51, the Y electrode driver 53, and the address driver 55) various control signals for sequentially performing driving according to each of a first reset process R1, a first selective write address process W1_{W} and a very small or minute light emission process LL. In the subfield SF2, which follows the subfield SF1, the drive control circuit 560 supplies to the panel drivers various control signals for sequentially performing driving according to each of a second reset process R2, a second selective write address process W2_{W}, and a sustain process I. In respective subfields SF3 to SF14, the drive control circuit 560 supplies to the panel drivers various control signals for sequentially performing driving according to each of the selective erase address process W_{D} and sustain process I. After executing the sustain process I, the drive control circuit 560 supplies to the panel driver various control signals for sequentially performing driving according to an erase process E only in the last subfield SF14 of the unit display period.

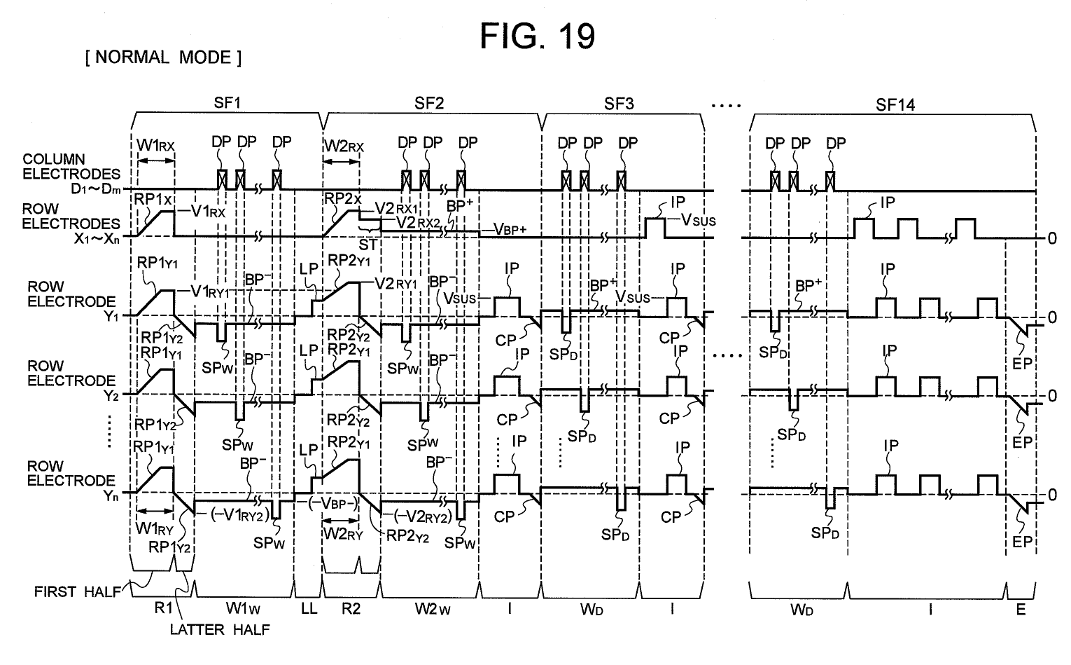

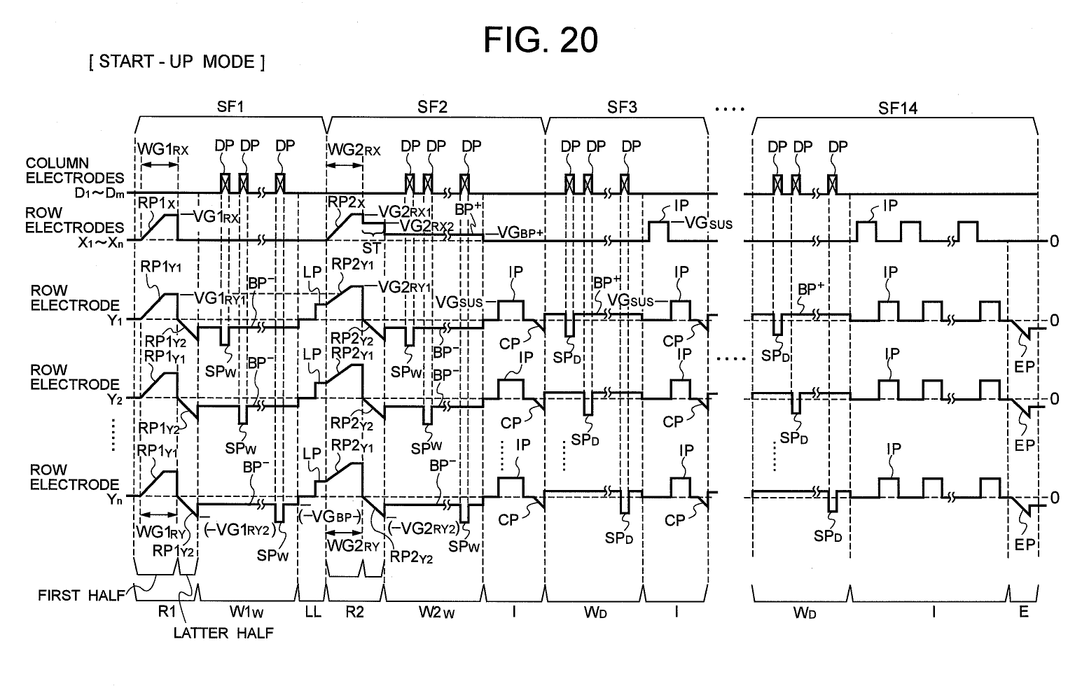

Here, similarly to the drive control circuit 56, the drive control circuit 560 executes upon power-on the drive mode setting process shown in FIG. 11. Thus, the drive control circuit 560 controls the panel drivers to supply to the column electrode D and the row electrodes X and Y of the PDP 50 various drive pulses as shown in FIG. 19 when in the normal mode and as shown in FIG. 20 when in the start-up mode.

FIGS. 19 and 20 show only the operation in the subfields SF1 to SF3 and the last subfield SF14 out of the subfields SF1 to SF14 shown in FIG. 18. The operations performed by the application of the various drive pulses are the same for the execution of the normal mode and that of the start-up mode.

Therefore, taking the case of the execution of the normal mode shown in FIG. 19 as an example, the application operation of the various drive pulses and the operations performed by the application of the drive pulses will be hereinafter described.

In the first half of a reset process R1 in the subfield SF1, the Y electrode driver 53 applies a reset pulse RP1_{Y1} to all the row electrodes Y₁ to Yₙ. The reset pulse RP1_{Y1} has a waveform whose potential transition at a leading edge with the lapse of time is gentle, compared with a sustain pulse. As shown in FIG. 19, a positive polarity peak potential V1_{RY1} of the reset pulse PR_{Y1} is a potential equal to or lower than the positive polarity peak potential V_{SUS} of a sustain pulse IP to be described later. During this time, the address driver 55 sets the column electrodes D₁ to Dₘ to the ground potential (0 volt) state. Upon the application of the reset pulse RP1_{Y1}, first reset discharge is generated between the respective row electrodes Y and column electrodes D in all the discharge cells PC. In other words, in the first half of the first reset process R1, a voltage is applied between the electrodes such that the anode side is the row electrode Y and the cathode side is the column electrode D. Thus, discharge for flowing current from the row electrode Y to the column electrode D, that is, column side cathode discharge, is generated as the first reset discharge. By the first reset discharge, wall charges of negative polarity are formed near the row electrode Y, and wall charges of positive polarity are formed near the column electrode D in all of the discharge cells PC.

In the first half of the first reset process R1, the X electrode driver 51 applies a reset pulse RP1_{X} respectively to all the row electrodes X₁ to Xₙ. The reset pulse RP1_{X} has the same polarity as that of the reset pulse RP1_{Y1}, and has a peak potential V1_{RX} of positive polarity that can prevent surface discharge generated between the row electrodes X and Y when the reset pulse RP1_{Y1} is applied.

Next, in the latter half of the first reset process R1, the Y electrode driver 53 generates a reset pulse RP1_{Y2} as shown in FIG. 19 and applies this to all the row electrodes Y₁ to Yₙ. The reset pulse RP1_{Y2} has a pulse waveform whose potential gradually falls with the lapse of time and reaches a negative polarity peak potential (−V1_{RY2}). Upon the application of the reset pulse RP1_{Y2} second reset discharge is generated between the row electrodes X and Y in all the discharge cells PC. The negative polarity peak potential (−V1_{RY2}) of the reset pulse RP1_{Y2} is a minimum potential that can generate the second reset discharge without fail between the row electrodes X and Y, which are determined by taking account of the wall charges formed in response to the first reset discharge respectively near the row electrodes X and Y. The peak potential (−V1_{RY2}) of the reset pulse RP1_{Y2} is set at a potential higher than the negative polarity peak potential of a write scan pulse SP_{W} to be described later, that is, a potential close to 0 volt. In other words, if the negative polarity peak potential (−V1_{RY2}) of the reset pulse RP1_{Y2} is set to be lower than the negative polarity peak potential of the write scan pulse SP_{W}, strong discharge is generated between the row electrode Y and the column electrode D, and a large amount of wall charges formed near the column electrode D are erased, and thus making the address discharge unstable in a first selective write address process W1_{W} to be described later. By the second reset discharge generated in the latter half of the first reset process R1, the wall charges formed respectively near the row electrodes X and Y in each discharge cell PC are erased, and all the discharge cells PC are initialized to OFF mode. Furthermore, upon the application of the reset pulse RP1_{Y2}, faint discharge is generated between the row electrode Y and the column electrode D in all the discharge cells PC, a part of the positive polarity wall charges formed near the column electrode D are erased, and is adjusted to an amount which can generate selective write address discharge correctly in the first selective write address process W1_{W}.

Next, in the first selective write address process W1_{W} in the subfield SF1, the Y electrode driver 53 sequentially and alternatively applies a write scan pulse SP_{W} having a negative polarity peak potential to the respective row electrodes Y₁ to Yₙ while simultaneously applying to the row electrodes Y₁ to Yₙ a base pulse BP⁻ having a predetermined potential (−V_{BP-}) of negative polarity as shown in FIG. 19. During this time, the X electrode driver 51 applies a voltage of 0 volt to the row electrodes X₁ to Xₙ respectively. Furthermore, in the first selective write address process W1_{W}, the address driver 55 generates a pixel data pulse DP corresponding to the logic level of the pixel drive data bit corresponding to the subfield SF1. For example, when the pixel drive data bit with the logic level 1 for setting the discharge cell PC to ON mode is supplied, the address driver 55 generates a pixel data pulse DP having a positive polarity peak potential. For the pixel drive data bit with the logic level 0 for setting the discharge cell PC to OFF mode, on the other hand, the address driver 55 generates a low voltage (0 volt) pixel data pulse DP. Then, the address driver 55 applies the pixel data pulse DP to the column electrodes D₁ to Dₘ for one display line (m pixels) at a time simultaneously in synchronization with the application timing of each write scan pulse SP_{W}. In this case, at the same time as the application of this write scan pulse SP_{W}, selective write address discharge is generated between the column electrode D and the row electrode Y in the discharge cell PC where the high voltage pixel data pulse DP for setting the discharge cell to ON mode is applied. By the selective write address discharge, the discharge cell PC is set to ON mode, where wall charges of positive polarity are formed near the row electrode Y, (wall charges of negative polarity are formed near the row electrode X,) and wall charges of negative polarity are formed near the column electrode D, respectively. The selective write address discharge is not generated between the column electrode D and the row electrode Y of the discharge cell PC where a low voltage (0 volt) pixel data pulse DP for setting the discharge cell to OFF mode is applied at the same time as the write scan pulse SP_{W}. Consequently, this discharge cell PC maintains the immediately preceding state, that is, the state of OFF mode initialized in the first reset process R1.

Then, in the minute light emission process LL in the subfield SF1, the Y electrode driver 53 simultaneously applies to the row electrodes Y₁ to Yₙ a minute light emission pulse LP having a predetermined positive polarity peak potential as shown in FIG. 19. Upon the application of the minute light emission pulse LP, discharge (hereinafter called very small or minute light emission discharge) is generated between the column electrode D and the row electrode Y in the discharge cell PC being set to ON mode. In other words, in the minute light emission process LL, such a potential is applied to the row electrode Y that will generate discharge between the row electrode Y and the column electrode D, but will not generate discharge between the row electrodes X and Y, in the discharge cell PC. Thus, the minute light emission discharge is generated only between the column electrode D and the row electrode Y in the discharge cell PC being set to On mode. Here, the positive polarity peak potential of the minute light emission pulse LP is a potential lower than the peak potential of the sustain pulse IP to be applied in the sustain process I in the subfield SF2 or subfields subsequent thereto (to be described later). As shown in FIG. 19, the rate of change of the minute light emission pulse LP during a rising period with the lapse of time is higher than that of the reset pulses (RP1_{Y1} and RP2_{Y1}). In other words, discharge stronger than the first reset discharge in the first reset process R1 is generated by shaping the potential transition of the minute light emission pulse LP at the leading edge to be steeper than that of the reset pulse. The luminescence brightness of this discharge is lower than that of the sustain discharge generated between the row electrodes X and Y, since the discharge is not only column side cathode discharge as already described but also discharge generated by the minute light emission pulse LP, whose peak potential is lower than the sustain pulse IP. In other words, in the minute light emission process LL, such discharge is generated as the minute light emission discharge that is accompanied by light emission whose brightness level is higher than that in the first reset discharge, but is accompanied by light emission whose brightness level is lower than that in the sustain discharge, that is, discharge accompanied by minute light emission whose level is barely high enough for use in displaying. In this case, selective write address discharge is generated, in a first selective write address process W1_{W} executed immediately before the minute light emission process LL, between the column electrode D and the row electrode Y in the discharge cell PC. Thus, brightness corresponding to a grayscale that is only one level higher than the brightness level 0 is represented in the subfield SF1.

After the minute light emission discharge, wall charges of negative polarity and wall charges of positive polarity are formed respectively near the row electrode Y and near the column electrode D.

In the first half of a second reset process R2 in the subfield SF2, the Y electrode driver 53 applies a reset pulse RP2_{Y1} to all the row electrodes Y₁ to Yₙ. Potential transition of the reset pulse RP2_{Y1} at a leading edge with the lapse of time is gentle compared with a sustain pulse IP to be described later, and the reset pulse RP2_{Y1} has a positive polarity peak potential V2_{RY1}. As shown in FIG. 19, the positive polarity peak potential V2_{RY1} of the reset pulse PR2_{Y1} is a potential equal to or lower than the positive polarity peak potential V_{SUS} of the sustain pulse IP. During this time, the address driver 55 sets the column electrodes D₁ to Dₘ to the ground potential (0 volt) state. The X electrode driver 51 applies a reset pulse RP2_{X} respectively to all the row electrodes X₁ to Xₙ. A positive polarity peak potential V2_{RX1} of the reset pulse RP2_{X} can prevent surface discharge generated between the row electrodes X and Y when the reset pulse RP2_{Y1} is applied. The positive polarity peak potential V2_{RY1} of the reset pulse PR2_{Y1} is a potential equal to or lower than the positive polarity peak potential V_{SUS} of the sustain pulse IP. In this case, if surface discharge is not generated between the row electrodes X and Y, the X electrode driver 51 may set all the row electrodes X₁ to Xₙ to the ground potential (0 volt) instead of applying the reset pulse PR2_{X}. Upon the application of the reset pulse PR2_{X}, first reset discharge weaker than column side cathode discharge in the minute light emission process LL is generated between the row electrode Y and the column electrode D in the discharge cell PC where the column side cathode discharge was not generated in the minute light emission process LL. In other words, in the first half of the second reset process R2, a voltage is applied between the electrodes such that the anode side is the row electrode Y and the cathode side is the column electrode D. Thus, discharge for flowing current from the row electrode Y to the column electrode D, that is, column side cathode discharge, is generated as the first reset discharge. On the other hand, in the discharge cell PC where minute light emission discharge has been generated in the minute light emission process LL, no discharge is generated even when the reset pulse PR2_{Y1} is applied. As a result, after the completion of the first half of the second reset process R2, wall charges of negative polarity are formed near the row electrode Y, and wall charges of positive polarity are formed near the column electrode D, in all of the discharge cells PC. In the latter half of the reset process R2 in the subfield SF2, the Y electrode driver 53 applies a reset pulse RP2_{Y2} as shown in FIG. 19 to the row electrodes Y₁ to Yₙ. The reset pulse RP2_{Y2} has a pulse waveform whose potential gradually falls with the lapse of time and reaches a negative polarity peak potential (−V2_{RY2}). In the latter half of the reset process R2, the X electrode driver 51 applies a potential V2_{RX2} respectively to all the row electrodes X₁ to Xₙ as a fixed potential for a falling step ST of the reset pulse RP2_{X}. The voltage V2_{RX2} has a positive polarity and a potential lower than that of the peak potential V2_{RX1}. Upon the application of the reset pulse RP2_{Y2} having negative polarity and the potential V2_{RX2} having positive polarity, the second reset discharge is generated between the row electrodes X and Y in all of the discharge cells PC. The negative polarity peak potential (−V2_{RY2}) of the reset pulse RP2_{Y2} and the positive potential V2_{RX2} are minimum potentials that can generate the second reset discharge without fail in response to the first reset discharge between the row electrodes X and Y, which are determined by taking account of the wall charges formed respectively near the row electrodes X and Y. The negative peak potential (−V2_{RY2}) of the reset pulse RP2_{Y2} is set at a potential higher than a peak potential of a negative polarity write scan pulse SP_{W}, that is, a potential close to 0 volt. In other words, if the peak potential of the reset pulse RP2_{Y2} is set to be lower than the negative polarity peak potential of the write scan pulse SP_{W}, strong discharge is generated between the row electrode Y and the column electrode D and a large amount of the wall charges formed near the column electrode D are erased, and thus making address discharge unstable in the second selective write address process W2_{W}.

In the second selective write address process W2_{W}, the Y electrode driver 53 sequentially and alternatively applies the write scan pulse SP_{W} having a negative polarity peak potential to the respective row electrodes Y₁ to Yₙ while simultaneously applying to the row electrodes Y₁ to Yₙ a base pulse BP⁻ as shown in FIG. 19 having a negative polarity potential (−V_{BP-}). During this time, the X electrode driver 51 applies to the row electrodes X₁ to Xₙ respectively a base pulse BP⁺ having a positive polarity peak potential V_{RP+}. Furthermore, in the second selective write address process W2_{W}, the address driver 55 first generates a pixel data pulse DP having a peak potential corresponding to the logic level of the pixel drive data bit corresponding to the subfield SF2. For example, when a pixel drive data bit with the logic level 1 for setting the discharge cell PC to ON mode is supplied, the address driver 55 generates a pixel data pulse DP having a positive polarity peak potential. For a pixel drive data bit with the logic level 0 for setting the discharge cell PC to OFF mode, on the other hand, the address driver 55 generates a low voltage (0 volt) pixel data pulse DP. Then, the address driver 55 applies the pixel data pulse DP to the column electrodes D₁ to Dₘ in synchronization with the application timing of each write scan pulse SP_{W} for one display line (m pixels) at a time simultaneously. In this case, selective write address discharge is generated between the column electrode D and the row electrode Y in the discharge cell PC where the high voltage pixel data pulse DP for setting the discharge cell to ON mode has been applied at the same time as the application of this write scan pulse SP_{W}. Immediately after this selective write address discharge, faint discharge is also generated between the row electrodes X and Y in the discharge cell PC. In other words, after the write scan pulse SP_{W} is applied, a voltage is applied between the row electrodes X and Y according to the base pulses BP⁻ and BP⁺. However, this voltage is set to a voltage lower than the discharge start voltage of each discharge cell PC. Thus, discharge is not generated in the discharge cell PC by the application of this voltage alone. If the selective write address discharge is generated, however, discharge is generated between the row electrodes X and Y, induced by this selective write address discharge, only by the voltage applied based on the base pulses BP⁻ and BP⁺. By this discharge and the selective write address discharge, the discharge cell PC is set to ON mode, where wall charges of positive polarity are formed near the row electrode Y wall charges of negative polarity are formed near the row electrode X, and wall charges of negative polarity are formed near the column electrode D, respectively. The selective write address discharge is not generated between the column electrode D and the row electrode Y of the discharge cell PC where a low voltage (0 volt) pixel data pulse DP for setting the discharge cell to OFF mode is applied at the same time as the application of the write scan pulse SP_{W}. Therefore, discharge is not generated between the row electrodes X and Y. Consequently, this discharge cell PC maintains the immediately preceding state, that is, the state of OFF mode initialized in the second reset process R2.

In the sustain process I in the subfield SF2, the Y electrode driver 53 generates only one pulse of a sustain pulse IP having a positive polarity peak potential V_{SUS}, and applies this to the respective row electrode Y₁ to Yₙ simultaneously. During this time, the X electrode driver 51 sets the row electrodes X₁ to Xₙ to the ground potential (0 volt). The address driver 55 sets the column electrodes D₁ to Dₘ to the ground potential (0 volt). Each time this sustain pulse IP is applied, sustain discharge is generated between the row electrodes X and Y in the discharge cell PC set to ON mode. The light emitted from the phosphor layer 17 is irradiated outside via the front transparent substrate 10 along with this sustain discharge, and thereby the display emission is performed for the number of times according to the brightness weight of the subfield SF2. Upon the application of the sustain pulse IP, discharge is also generated between the row electrode Y and the column electrode D in the discharge cell PC which is set to the ON mode. By this discharge and the above sustain discharge, wall charges of negative polarity are formed near the row electrode Y, wall charges of positive polarity are formed near the row electrode X and the column electrode D, respectively in the discharge cell PC. After the sustain pulse IP is applied, the Y electrode driver 53 applies a wall charge adjustment pulse CP to the row electrodes Y₁ to Yₙ. As shown in FIG. 19, the wall charge adjustment pulse CP has a negative polarity peak potential whose transition at the leading edge with the lapse of time is gentle. As this wall charge adjustment pulse CP is applied, faint erase discharge is generated in the discharge cell PC where the above sustain discharge is generated, and a part of the wall charges formed inside the discharge cell is erased. Thus, the amount of the wall charges in the discharge cell PC is adjusted to an amount that can generate the selective erase address discharge correctly in the next selective erase address process W_{D}.

Then, in the selective erase address process W_{D} in each of the subfield SF3 to SF14, the Y electrode driver 53 sequentially and alternatively applies an erase scan pulse SP_{D} to the respective row electrodes Y₁ to Yₙ while applying the base pulse BP+to the respective row electrodes Y₁ to Yₙ. The erase scan pulse SP_{D} has a negative polarity peak potential as shown in FIG. 19. The base pulse BP⁺ has a positive polarity peak potential V_{BP+}. The peak potential V_{BP+} of the base pulse BP⁺ is set to a potential that can prevent incorrect discharge between the row electrodes X and Y while the selective erase address process W_{D} is being executed. Also, during the execution of the selective erase address process W_{D}, the X electrode driver 51 sets each of the row electrodes X₁ to Xₙ to the ground potential (0 volt). In this selective erase address process W_{D}, the address driver 55 first converts a pixel drive data bit corresponding to the subfield SF into a pixel data pulse DP having a peak potential according to the logic level thereof. For example, when the pixel drive data bit with the logic level 1 for shifting the discharge cell PC from ON mode to OFF mode is supplied, the address driver 55 converts this into a pixel data pulse DP having a positive polarity peak potential. When a pixel drive data bit with the logic level 0 for maintaining the current state of the discharge cell PC is supplied, on the other hand, the address driver 55 converts this into a low voltage (0 volt) pixel data pulse DP. The address driver 55 then applies the pixel data pulse DP to the column electrodes D₁ to Dₘ in synchronization with the application timing of each erase scan pulse SP_{D} for one display line (m pixels) at a time simultaneously. In this case, selective erase address discharge is generated between the column electrode D and the row electrode Y in the discharge cell PC where the high voltage pixel data pulse DP was applied at the same time as the application of the erase scan pulse SP_{D}. By this selective erase address discharge, this discharge cell PC is set to OFF mode, where wall charges of positive polarity are formed near the row electrodes Y and X, and wall charges of negative polarity are formed near the column electrode D. This selective erase address discharge is not generated between the column electrode D and the row electrode Y in the discharge cell PC where the low voltage (0 volt) pixel data pulse DP was applied at the same time as the erase scan pulse SP_{D}. Therefore, this discharge cell PC maintains the immediately preceding state of (ON mode or OFF mode).

In the sustain process I in each of subfield SF3 to SF14, the X electrode driver 51 and the Y electrode driver 53 apply, as shown in FIG. 19, the sustain pulse IP having a positive polarity peak potential V_{SUS} to the row electrodes Y₁ to Yₙ and X₁ to Xₙ (alternately to the row electrodes X and Y) repeatedly for the number of times corresponding to the brightness weight of the subfield. Each time this sustain pulse IP is applied, sustain discharge is generated between the row electrodes X and Y in the discharge cell PC set to ON mode. The light emitted from the phosphor layer 17 is irradiated outside via the front transparent substrate 10 along with this sustain discharge, and thereby the display emission is performed for the number of times according to the brightness weight of the subfield SF. The total number of the sustain pulses IP applied in each sustain process I is an even number. In other words, in each sustain process I, a first sustain pulses IP is applied to the row electrode X and a last sustain pulses IP to the row electrode Y. Thus, immediately after the completion of each sustain process I, wall charges of negative polarity are formed near the row electrode Y, and wall charges of positive polarity are formed respectively near the row electrode X and the column electrode D, in the discharge cell PC where the sustain discharge has been generated. Thus, the state of wall charges formed in each discharge cell PC becomes the same as that of immediately after the completion of the first reset discharge.

After the completion of the sustain process I of the last subfield SF14, the Y electrode driver 53 applies an erase pulse EP having a negative polarity peak potential to all the row electrodes Y₁ to Yₙ. Upon the application of this erase pulse EP, erase discharge is generated only in the discharge cell PC in ON mode. By this erase discharge, the discharge cell PC in ON mode shifts to OFF mode.

The driving as described above is executed according to the sixteen types of pixel drive data GD shown in FIG. 17.

First, in second grayscale, which represents a brightness level only one level brighter than first grayscale which displays black (the brightness level 0), selective write address discharge is generated. The selective write address discharge sets the discharge cell PC to ON mode only in the subfield SF1 out of the subfields SF1 to SF14. In the discharge cell PC set to ON mode, minute light emission discharge is generated (indicated by a square). In this case, the brightness level of the light emission that accompanies these selective write address discharge and minute light emission discharge is lower than that of the light emission that accompanies one sustain discharge. Thus, brightness corresponding to a brightness level “alpha,” which is lower than the brightness level “1,” is represented by second grayscale when the brightness level visually recognized for the sustain discharge is “1”.

Next, in third grayscale, which represents a brightness level only one level brighter than second grayscale, selective write address discharge (indicated by dual circles) is generated. The selective write address discharge sets the discharge cell PC to ON mode only in the subfield SF2 out of the subfields SF1 to SF14. Then, in the next subfield SF3, selective erase address discharge (indicated by a solid black circle) for shifting the discharge cell PC to OFF mode is generated. Thus, in third grayscale, light emission for one sustain discharge is performed only in the sustain process I in the subfield SF2 out of the subfields SF1 to SF14, and brightness corresponding to the brightness level “1” is displayed.

Next, in fourth grayscale, which represents brightness only one level brighter than third grayscale, selective write address discharge for setting the discharge cell PC to ON mode is first generated in the subfield SF1. In the discharge cell PC set to ON mode, minute light emission discharge is generated (indicated by a square). In the fourth grayscale, selective write address discharge (indicated by dual circles) is generated. The selective write address discharge sets the discharge cell PC to ON mode only in the subfield SF2 out of the subfields SF1 to SF14. Then, in the next subfield SF3, selective erase address discharge (indicated by a solid black circle) for shifting the discharge cell PC to OFF mode is generated. Thus, in fourth grayscale, light emission corresponding to the brightness level “alpha” is performed in the subfield SF1, and only one sustain discharge that is accompanied by light emission of the brightness level “1” is performed in the subfield SF2, and thereby, brightness corresponding to the brightness level “alpha” plus “1” is displayed.

In respective fifth to sixteenth grayscales, selective write address discharge for setting the discharge cell PC to ON mode is generated in the subfield SF1. Minute light emission discharge (indicated by a square) is generated in the discharge cell PC set to ON mode. The selective erase address discharge (indicated by a solid black circle) for shifting the discharge cell PC to OFF mode is generated only in one subfield corresponding to the grayscale. Thus, in each of the fifth to sixteenth grayscales, the minute light emission discharge is generated in the subfield SF1. In the subfield SF2, one sustain discharge is generated, and then, sustain discharge are generated in each of the consecutive subfields (indicated by a circle) consecutive for the number of times corresponding to the grayscale and repeated for the number of times assigned to the subfield. Thus, in each of fifth to sixteenth grayscales, the brightness corresponding to the brightness level “alpha” plus “the total number of sustain discharges generated in one field (or one flame) of a display period” is visually recognized Therefore, according to the driving illustrated in FIGS. 17-20, a brightness range from brightness levels “0” to “255 plus alpha” can be displayed with sixteen levels as shown in FIG. 17.

In the driving shown in FIGS. 17 to 20, minute light emission discharge, but not sustain discharge, is generated as discharge contributing to displaying an image in the subfield SF1, which has a smallest brightness weight. Since the minute light emission discharge is generated between the column electrode D and the row electrode Y, the brightness level thereof that accompanies the discharge at the time of emission is lower compared with the sustain discharge that is generated between the row electrodes X and Y. Therefore, when displaying a brightness level only one level higher than black display (the brightness level 0) (second grayscale) with the minute light emission discharge, brightness difference from the brightness level 0 becomes small compared with the case where second grayscale is displayed by sustain discharge. Thus, the grayscale display ability for displaying a low brightness image is enhanced. In second grayscale, no reset discharge is generated in the second reset process R2 in the subfield SF2, which follows the subfield SF1, and thereby degradation in dark contrast can be suppressed. In the driving shown in FIG. 17, the minute light emission discharge accompanied by light emission having the brightness level alpha is generated in the subfield SF1 in the respective grayscales after fourth grayscale. However, the minute light emission discharge may not be generated in grayscales after third grayscale. In short, emission accompanying the minute light emission discharge has an extremely low brightness level (the brightness level alpha). In fourth grayscale or after, where sustain discharge having brighter emission is used in combination therewith, there are cases where the brightness added by the brightness level alpha cannot be visually perceived, and thus negating the significance of generating the minute light emission discharge.

Here, in the plasma display device shown in FIG. 16, the driving is performed according to the normal mode shown in FIG. 19 after the passage of a predetermined period of time (for example, a minute) since power-on, and during the start-up time, according to the start-up mode as shown in FIG. 20.

In the start-up mode, the pulse waveforms of the various drive pulses such as the reset pulse RP1_{X}, RP2_{X}, RP1_{Y1}, RP2_{Y1}, RP1_{Y2}, RP2_{Y2}, sustain pulse IP, and base pulses BP⁺ and BP⁻ are different from those in the case of the normal mode.

To be more specific, the following potentials and pulse widths are adopted in the start-up mode:

(1) a potential VG1_{RX} lower than the potential V1_{RX} as the positive polarity peak potential of the reset pulse RP1_{X};

(2) a potential VG1_{RY1} higher than the potential V1_{RY1} as the positive polarity peak potential of the reset pulse RP1_{Y1};

(3) a potential (−VG1_{RY2}) lower than the potential (−V1_{RY2}) as the negative polarity peak potential of the reset pulse RP1_{Y2};

(4) a potential VG2_{RX} lower than the potential V2_{RX1} as the positive polarity peak potential of the reset pulse RP2_{X};

(5) a potential VG2_{RX2} higher than the potential V2_{RX2} as a potential for a falling step ST of the reset pulse RP2_{X};

(6) a potential VG2_{RY1} higher than the potential V2_{RY1} as the positive polarity peak potential of the reset pulse RP2_{Y1};

(7) a potential (−VG2_{RY2}) lower than the potential (−V2_{RY2}) as the negative polarity peak potential of the reset pulse RP2_{Y2};

(8) a potential (−VG_{BP-}) lower than the potential (−V_{BP-}) as the peak potential of the base pulse BP⁻;

(9) a potential VG_{BP+} higher than the potential V_{BP+} as the peak potential of the base pulse BP⁺;

(10) a potential VG_{SUS} higher than the potential V_{SUS} as the positive polarity peak potential of the sustain pulse IP;

(11) a pulse width WG1_{RY} wider than the pulse width W1_{RY} as the pulse width of the reset pulse RP1_{Y1};

(12) a pulse width WG2_{RY} wider than the pulse width W2_{RY} as the pulse width of the reset pulse RP2_{Y1};

(13) a pulse width WG1_{RX} narrower than the pulse width W1_{RX} as the pulse width of the reset pulse RP1_{X}; and

(14) a pulse width WG2_{RX} narrower than the pulse width W2_{RX} as the pulse width of the reset pulse RP2_{X}.

Any one of the above (1)-(14) or a combination of at least two out of the above (1)-(14) may be adopted.

That is, in the first half of the reset process (R1, R2) in the start-up mode, the positive polarity peak potential of reset pulse (RP1_{Y1}, RP2_{Y1}) is set to a potential (VG1_{RY1}, VG2_{RY1}) higher than the potential (V1_{RY1}, V2_{RY1}) in the normal mode, and the positive polarity peak potential of the reset pulse (RP1_{X}, RP2_{X}) is set to a potential (VG1_{RX}, VG2_{RX1}) lower than the potential (V1_{RX}, V2_{RX1}) in the normal mode. The pulse width of the reset pulse (RP1_{Y1}, RP2_{Y1}) is set to a pulse width (WG1_{RY}, WG2_{RY}) wider than the pulse width (W1_{RY}, W2_{RY}) in the normal mode, and the pulse width of the reset pulse (RP1_{X}, RP2_{X}) is set to a pulse width (WG1_{RX}, WG2_{RX}) narrower than the pulse width (W1_{RX}, W2_{RX}) in the normal mode. Thus, the voltage applied between the row electrodes X and Y in the start-up mode becomes higher than in the normal mode and the generation of the column side cathode discharge between the row electrode Y and the column electrode D becomes easy. The greater the voltage (field intensity) applied between the row electrodes X and Y is, the more easy the generation of the column side cathode discharge between the row electrode Y and column electrode D becomes induced by the electric field. However, if the voltage is excessively increased, there is a possibility that discharge may be generated between the row electrodes X and Y, and therefore, a voltage that does not generate such discharge is applied.

In the latter half of the reset process R in the start-up mode, the negative polarity peak potential of reset pulse (RP1_{Y2}, RP2_{Y2}) is set to a potential (−VG1_{RY2}, −VG2_{RY2}) lower than the potential (−V1_{RY2}, −V2_{RY2}) in the normal mode, and thereby the voltages applied in the start-up mode between the row electrodes X and Y and between the row electrode Y and column electrode D become higher than in the normal mode and the generation of the discharge between the row electrodes X and Y and between the row electrode Y and column electrode D becomes easy.

In the selective write address process (W1_{W}, W2_{W}) in the start-up mode, the peak potential of the base pulse BP⁻ is set to a potential (−VG_{BP-}) lower than the potential (−V_{BP-}) in the normal mode, and the peak potential of the base pulse BP⁺ is set to a potential VG_{BP+} higher than the potential V_{BP+} in the normal mode. Thus, the voltages applied between the row electrodes X and Y and between the row electrode Y and column electrode D become higher than in the normal mode, and the generation of the write address discharge between the row electrodes X and Y, and between the row electrode Y and the column electrode D becomes easy.

In the sustain process I in the start-up mode, the positive polarity peak potential of the sustain pulse IP is set to a potential VG_{SUS} higher than the potential V_{SUS} in the normal mode. Thus, the voltage applied between the row electrodes X and Y become higher than in the normal mode, and the generation of the sustain discharge becomes easy between the row electrodes X and Y. In the only one sustain discharge in the sustain process I in the subfield SF2, the column side cathode discharge is also generated between the row electrode Y and the column electrode D. In this case, the voltage is increased between the row electrode Y and the column electrode D, and the generation of this column side cathode discharge also becomes easy.

In other words, in the start-up mode, the positive polarity peak potentials of the various drive pulses are set to be higher than in the normal mode and the negative polarity peak potential to be lower than in the normal mode. Thus, the voltages applied between the row electrodes X and Y, and between the row electrode Y and the column electrode D are increased such that discharge is generated without fail.

Consequently, the generation of the various discharge can be ensured even if the discharge characteristics of the respective discharge cells are varied for a predetermined start-up period of time (for example, a minute) from power-on due to the garbage gas contained in the MgO crystals provided within the discharge cells for the improvement of dark contrast. Accordingly, deterioration in the image quality can be suppressed at power-on while improving dark contrast.

After a lapse of the start-up time, the driving is shifted to the normal mode. Faint reset discharge is generated in the reset process R, and thereby dark contrast is improved. The power consumption can be also reduced.

In particular, when the phosphor layer contains MgO crystals as a secondary electron emissive material as in the PDP 50, it means that the phosphor layer contains a secondary electron emissive material that is prone to absorb garbage gas. Then, there arises a problem that the discharge characteristics become unstable during the start-up time compared with a PDP that does not contain MgO crystals. This problem can be resolved by adopting the above constitution.

In a PDP that contains CL light emissive MgO crystals in a phosphor layer, reset discharge is very faint. The effect of the dispersion in the discharge generated in the respective cells is therefore more serious. In other words, there arises a problem that even small variations in the discharge characteristics can become the cause of a discharge cell wherein no reset discharge is generated. Such a problem, too, can be resolved by adopting the constitution of the present embodiment.

In the plasma display device shown in FIG. 16, since the peak potentials of the various drive pulses are set to be different in the start-up mode and normal mode, power sources that correspond to the peak potentials of the drive pulses are provided for each of the modes. For example, a first power source for generating the potential V1_{RY1} (potential V2_{RY1}) for the normal mode, and a second power source for generating the potential VG1_{RY1} (VG2_{RY1}) for the start-up mode are provided within the power supply circuit 60 as power sources for generating the positive polarity peak potentials of the reset pulse RP1_{Y1} (RP2_{Y1}). The Y electrode driver 53 alternatively uses the potential VG1_{RY1} (VG2_{RY1}) generated by the second power source for the start-up mode or the potential V1_{RY1} (V2_{RY1}) generated by the first power source for the normal mode, and thereby generates the peak potential of the reset pulse PR_{Y1} (PR2_{Y1}).

However, not only the positive polarity peak potential VG1_{RY1} (VG2_{RY1}) for the start-up mode but also the positive polarity peak potential V1_{RY1} (V2_{RY1}) for the normal mode may be generated by using only the second power source out of the first and second power sources and by controlling the rising period of the pulse.

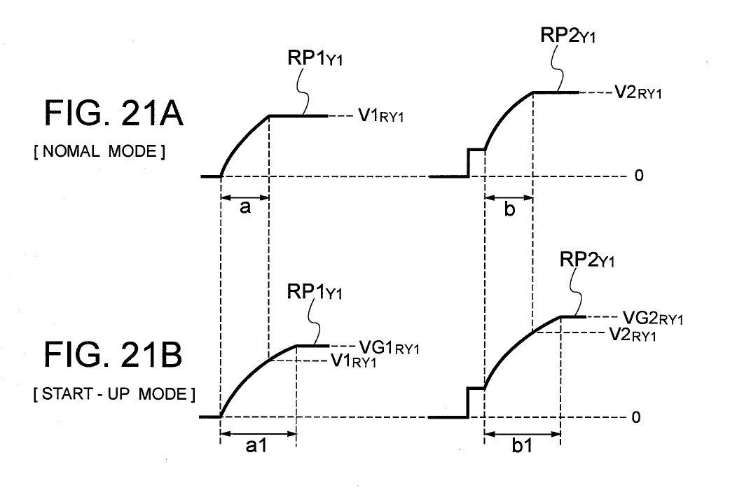

In the normal mode, for example, the Y electrode driver 53 applies to the row electrode Y the potential VG1_{RY1} (VG2_{RY1}) generated by the second power source during a time period a (time period b) as shown in FIG. 21(A), Thus, load capacitance parasitic between the row electrodes X and Y of the PDP 50 is charged, and the potential of the Y electrode gradually rises from 0 volt with a lapse of time as shown in FIG. 21(A). The potential of the Y electrode reaches the potential V1_{RY1} (V2_{RY1}) after the time period a (time period b) has passed since the potential began to rise. The Y electrode 53 set the Y electrode in a high impedance state at the time point when the time period a (time period b) has passed, and thereby the row electrode Y maintains the potential state at the time point when the time period a (time period b) has passed. This potential state becomes, as shown in FIG. 21(A), the positive polarity peak potential V1_{RY1} (V2_{RY1}) of the reset pulse RP1_{Y1} (RP2_{Y1}) in the normal mode.

In the start-up mode, on the other hand, the Y electrode driver 53 applies to the Y electrode the potential VG1_{RY1} (VG2_{RY1}) generated by the second power source during a time period a1 (time period b1), which is longer than the time period a (time period b), as shown in FIG. 21(B). Thus, the load capacitance parasitic between the row electrodes X and Y of the PDP 50 is charged, and the potential of the Y electrode gradually rises with a lapse of time as shown in FIG. 21(B) from 0 volt. The potential of the Y electrode reaches the potential VG1_{RY1} (VG2_{RY1}) after the passage of the time period a1 (time period b1) since the potential began to rise. The Y electrode driver 53 sets the Y electrode in a high impedance state at a time point when the time period a1 (time period b1) has passed. Thus, the row electrode Y maintains the potential state at the time point when the time period a1 (time period b1) has passed. This potential state becomes, as shown in FIG. 21(B), the positive polarity peak potential VG1_{RY1} (VG2_{RY1}) of the reset pulse RP1_{Y1} (RP2_{Y1}) in the start-up mode.

It should be noted that the waveform of the reset pulse RP1_{Y1} (RP1_{Y2}) is not limited to those shown in FIG. 19 and 20. It may be such a waveform, for example, as shown in FIG. 14 whose slope of voltage transition gradually changes with a lapse of time.

Furthermore, although in the reset process (R1, R2) shown in FIGS. 20 and 21 reset discharge are generated simultaneously in all of the discharge cells, the reset discharge may be performed in respective discharge cell blocks which respectively comprises a plurality of discharge cells such that the reset discharge may be generated in a way dispersed on the time axis.

In the first reset process R1 shown in FIGS. 19 and 20, the reset pulses RP1_{Y1} and RP1_{X} are applied in the first half to all of the row electrodes X and Y, and thereby first reset discharge are generated as column side cathode discharge. However, the application of these reset pulses RP1_{Y1} and RP1_{X} may be omitted.

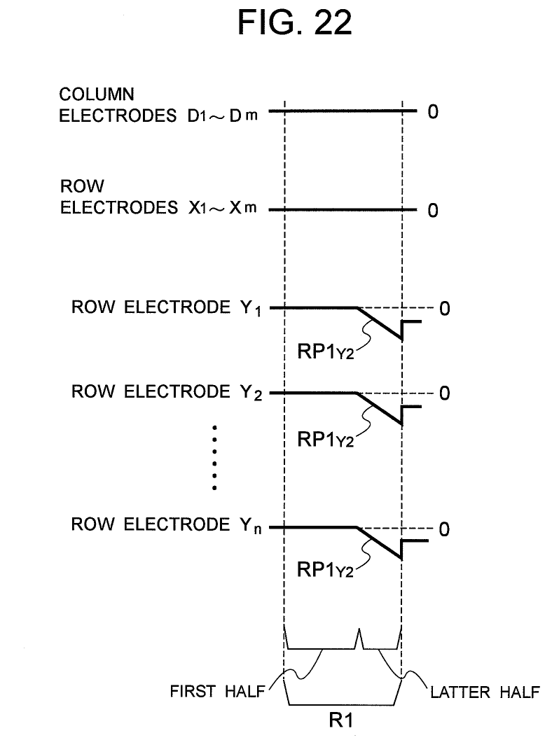

For example, first reset process R1 shown in FIG. 22 is adopted instead of first reset process R1 shown in FIGS. 19 and 20. As shown in FIG. 22, in the first half of the first reset process R1 the row electrodes Y₁ to Yₙ are fixed to the ground potential.

This application is based on Japanese patent application No. 2007-131795 which is hereby incorporated by reference.

What is claimed is:

1. A plasma display device of driving a plasma display panel in accordance with pixel data for each pixel obtained from a video signal, said plasma display panel including a discharge cell formed at each of intersections of a plurality of row electrode pairs and a plurality of column electrodes, the device comprising:
a phosphor layer formed on a surface of each discharge cell and containing a secondary electron emissive material; and a drive part for applying a drive pulse to each of said row electrode pairs and said column electrodes in each of a plurality of subfields for a unit display period of said video signal,
wherein said drive part uses a pulse waveform of said drive pulse for a period from power-on of said plasma display device to a lapse of a predetermined period of time, different from a pulse waveform of said drive pulse for a period after a lapse of said predetermined period of time.

2. A method for driving a plasma display panel in accordance with pixel data for each pixel obtained from a video signal, said plasma display panel including a discharge cell formed at each of intersection of a plurality of row electrode pairs and a plurality of column electrodes, and a phosphor layer formed on a surface of each discharge cell and containing a secondary electron emissive material, the method comprising:
applying a drive pulse to each of said row electrode pairs and said column electrodes in each of a plurality of subfields for a unit display period of said video signal;
using a pulse waveform of said drive pulse for a period from power-on of said plasma display device to a lapse of a predetermined period of time, different from a pulse width of said drive pulse for a period after a lapse of said predetermined period of time.

3. The method for driving a plasma display panel according to claim 2, wherein a peak potential and/or pulse width of said drive pulse is different for said period from power-on to a lapse of said predetermined period of time, and for said period after a lapse of said predetermined period of time.

4. The method for driving a plasma display panel according to claim 2, wherein a peak potential of said drive pulse generated for said period from power-on to a lapse of said predetermined period of time is higher than that of said drive pulse generated for said period after a lapse of said predetermined period of time.

5. The method for driving a plasma display panel according to claim 2, wherein a pulse width of said drive pulse generated for said period from power-on to a lapse of said predetermined period of time is wider than that of said drive pulse generated for said period after a lapse of said predetermined period of time.

6. The method for driving a plasma display panel according to claim 2 comprising:
applying a reset pulse to said row electrode pair at least in one subfield in each of said plurality of subfields;
in each of said subfields, sequentially applying a scan pulse to respective one row electrode of each of said row electrode pairs, while applying a first base pulse to said one row electrode, and a second base pulse to the other row electrode of each of said row electrode pairs, and selectively applying to said column electrode a pixel data pulse corresponding to said pixel data, and thereby setting said discharge cell in either one of ON mode and OFF mode; and
applying a sustain pulse to each of said row electrode pairs in each of said subfields,
wherein said drive pulse is at least one of said reset pulse, said first base pulse, said second base pulse, and said sustain pulse.

7. The method for driving a plasma display panel according to claim 6, wherein a waveform of said reset pulse is changed from said first waveform to said second waveform at a time point of the lapse of said predetermined period of time such that a voltage between said one row electrode and said other row electrode becomes higher in said predetermined period of time than in said period after a lapse of said predetermined period of time.

8. The method for driving a plasma display panel according to claim 6, wherein waveforms of said first and second base pulses are changed from said first to second waveform at a time point of the lapse of said predetermined period of time such that a voltage between said one row electrode and said other row electrode becomes higher in said predetermined period of time than in said period after a lapse of said predetermined period of time.

9. The method for driving a plasma display panel according to claim 6, wherein a waveform of said sustain pulse is changed from said first to second waveform at a time point after a lapse of said predetermined period of time such that a voltage between said one row electrode and said other row electrode becomes higher in said predetermined period of time than in said period after a lapse of said predetermined period of time.

10. The method for driving a plasma display panel according to claim 2, wherein said secondary electron emissive material comprises magnesium oxide.

11. The method for driving a plasma display panel according to claim 10, wherein said magnesium oxide contains magnesium oxide crystals which are excited by the irradiated electron beam and perform Cathode Luminescence (CL) emission whose peak falls within a wavelength range of 200 to 300 nm.

12. The method for driving a plasma display panel according to claim 11, wherein said magnesium oxide crystals comprise magnesium oxide monocrystals generated by vapor-phase oxidation.

13. The method for driving a plasma display panel according to claim 2, wherein said secondary electron emissive material contacts said discharge gas in said discharge space.

14. The method for driving a plasma display panel according to claim 2 further comprising:
a reset process for initializing said discharge cell to OFF mode in a first subfield of said unit display period; and
a write address process for shifting said discharge cell from OFF mode to ON mode selectively in accordance with said pixel data,
wherein, in said reset process, a voltage between the electrodes such that the anode side is said one row electrode and the cathode side is the column electrode is applied.

15. The method for driving a plasma display panel according to claim 14, wherein in said reset process, a potential for preventing discharge between the other row electrode of said row electrode pair and said one row electrode is applied to said other row electrode of said row electrode pair.

16. The method for driving a plasma display panel according to claim 14, wherein in said first subfield, only one sustain pulse is applied only to said one row electrode out of said one row electrode and the other row electrode of said row electrode pair.

17. The method for driving a plasma display panel according to claim 14, wherein said reset process is executed only in said first subfield in each of said subfields in said unit display period.

18. The method for driving a plasma display panel according to claim 14 further comprising: an erase address process for shifting said discharge cell from ON mode to OFF mode selectively in each of subfields that follow said first subfield in accordance with said pixel data.

19. The method for driving a plasma display panel according to claim 14, wherein in said reset process, a voltage is generated between said column electrode and said one row electrode by gradually increasing the potential applied to said one row electrode with a lapse of time.

20. The method for driving a plasma display panel according to claim 14, wherein in said write address process, a first base pulse of negative polarity is applied to said one row electrode and a second base pulse of positive polarity is applied to the other row electrode of said row electrode pair.

21. The method for driving a plasma display panel according to claim 2, wherein a reset process and an address process are executed, said reset process being for initializing said discharge cell to either one of ON mode or OFF mode at least in each of a first subfield and a second subfield which comes immediately after said first field in a unit display period, and said address process being for shifting said discharge cell to the other one of ON mode or OFF mode selectively in accordance with said pixel data in each of said first subfield and said second subfield, and
wherein in said reset process, a voltage between the electrodes such that the anode side is said one row electrode and the cathode side is the column electrode is applied in said second subfield.

22. The method for driving a plasma display panel according to claim 21, wherein in said reset process, a voltage between the electrodes such that the anode side is said one electrode and the cathode side is said column electrode is applied in said first subfield.

23. The method for driving a plasma display panel according to claim 21, wherein in said reset process said discharge cell is initialized to OFF mode, and
wherein in said address process, said discharge cell is shifted to ON mode selectively in accordance with said pixel data.

24. The method for driving a plasma display panel according to claim 21, wherein in said reset process, a potential for preventing discharge between the other electrode of said row electrode pair and said one row electrode is applied to said other electrode.

25. The method for driving a plasma display panel according to claim 21, wherein in said reset process a potential of positive polarity to each of said one electrode and the other row electrode of said row electrode pair is applied.

26. The method for driving a plasma display panel according to claim 21, wherein very small or minute light emission discharge is generated in said first subfield between said column electrode and said one row electrode in said discharge cell set to ON mode by applying a voltage between the electrodes such that the anode side is said one row electrode and the cathode side is said column electrode.

27. The method for driving a plasma display panel according to claim 26, wherein said minute light emission discharge is discharge accompanied by light emission corresponding to a grayscale brighter than the brightness level 0 only by one level

28. The method for driving a plasma display panel according to claim 26, wherein in a reset process of said second subfield, reset discharge is generated by gradually increasing with a lapse of time the potential applied to said one row electrode so as to generate said minute light emission discharge.

29. The method for driving a plasma display panel according to claim 26, wherein a rate of change, in a rising period with a lapse of time, of said potential applied to said one row electrode to generate said minute light emission discharge is higher than a rate of change, in a rising period with a lapse of time, of said potential applied to said one row electrode to generate reset discharge.

30. The method for driving a plasma display panel according to claim 26, wherein a sustain process is executed in each of subfields that follow said second subfield, said sustain process being for applying a sustain pulse to said one row electrode and the other row electrode of said row electrode pair, and
wherein said potential applied to said one row electrode for generating said minute light emission discharge is lower than a peak potential of said sustain pulse.

31. The method for driving a plasma display panel according to claim 21, wherein only one sustain pulse is applied only to said ones of row electrodes in said second subfield.

32. The method for driving a plasma display panel according to claim 21, wherein in said address process, said discharge cell is shifted from ON mode to OFF mode by selectively in accordance with said pixel data in each subfields that follow said second subfield.

33. The method for driving a plasma display panel according to claim 21, wherein the voltage between said one row electrode and said column electrode is gradually increased by gradually increasing with a lapse of time the potential applied to said ones of row electrodes.
